(19) United States
(12) Patent Application Publication
(10) Pub. No.: US 2023/0392356 A1
(43) Pub. Date: Dec. 7, 2023

(54) WEAR ASSEMBLY

(71) Applicant: Bradken Resources Pty Limited, New South Wales (AU)

(72) Inventors: Christopher David EDMONDS, New South Wales (AU); Terry L. BRISCOE, Portland, OR (US); Adam SCRIVEN, New South Wales (AU)

(73) Assignee: Bradken Resources Pty Limited, New South Wales (AU)

(21) Appl. No.: 18/032,983

(22) PCT Filed: Aug. 25, 2021
(86) PCT No.: PCT/AU2021/050972

§ 371 Date: Apr. 20, 2023

(30) Foreign Application Priority Data
Oct. 20, 2020 (AU) 2020903796
Jun. 9, 2021 (AU) 2021901737

(51) Int. Cl. E02F 9/28

(52) U.S. Cl. CPC E02F 9/2841

(57) ABSTRACT

A lock is disclosed for securing a wear member to a support structure. The lock is arranged to be movable within the locking hole formed in the wear member. In some forms, at least one latch is disposed on the lock body of the lock mounted within the wear member and has a detent movable transverse to an axis of the lock body and arranged in use to restrain movement of the lock in the locking hole. In some forms, multiple retainers are provided to restrain movement of the lock body in the locking hole. A wear member, wear assembly and associated methods are also disclosed.

### CROSS-REFERENCE TO RELATED APPLICATIONS

This application is a national stage application under 35 USC 371 of International Application No. PCT/AU2021/050972, filed Aug. 25, 2021, which claims the priority of Australian Application No. 2020903796, filed Oct. 20, 2020 and Australian Application No. 2021901737, filed Jun. 9, 2021, the entire contents of each priority application are incorporated herein by reference.

### FIELD OF THE DISCLOSURE

This disclosure relates to excavation wear assemblies, locks for use in such wear assemblies and to components and methods of such excavation wear and lock assemblies. The disclosure has application in earth working equipment such as land based digging equipment and is herein described in that context. However, it is to be appreciated that the disclosure has broader application for example in waterborne excavation equipment such as dredgers, and is therefore not limited to that application.

### BACKGROUND OF THE DISCLOSURE

Wear members are provided on the digging edge of various pieces of digging equipment such as the buckets of front end loaders. The wear assembly is often formed of a number of parts, commonly a wear member, a support structure and a lock. The support structure is typically fitted to the excavation equipment and the wear member fits over the support structure and is retained in place by the lock. In some instances, one or more intermediate parts may be also included between the wear member and the support structure. For ease of description it is to be understood that, unless the context requires otherwise, the term “support structure” used in this specification includes both the support structure arranged to be fitted to, or forming an integral part of, the excavation equipment or, if one or more intermediate parts are provided, to that intermediate part(s) or to the combination of the support structure and the intermediate part(s).

The reason that the wear assembly is formed of a number of parts is to avoid having to discard the entire wear assembly when only parts of the wear member, in particular the ground engaging part of the wear assembly (i.e. the wear member) is worn or broken.

Various types of locks, wear members and support structures are known. However, there is a continuing aim to design new wear assemblies and parts thereof to take into account installation, performance and manufacturing considerations.

It is to be understood that, if any prior art is referred to herein, such reference does not constitute an admission that the prior art forms a part of the common general knowledge in the art, in Australia or any other country.

### SUMMARY OF THE DISCLOSURE

The present disclosure relates generally to wear assemblies for earth working equipment and to components of such assemblies including locks and wear members, and to methods associated with those assemblies.

In a first aspect, disclosed is a lock for securing a wear member to a support structure, the wear member having a body that incorporates a cavity configured to receive the support structure, and a locking hole extending to the cavity. The lock is arranged to be movable within the locking hole and includes a lock body extending along a lock body axis and having a first end region for engaging with the support structure to allow securing of the wear member with the support structure. At least one latch is disposed on the lock body and has a detent movable transverse to the lock body axis and being arranged in use to restrain movement of the lock in the locking hole.

In some forms, the locking hole may extend from the exterior of the wear member body to the cavity.

In some forms, the detent is movable to a position where it projects from the lock body. In some forms, the at least one latch further comprises a resilient member operative to allow transverse movement of the detent on deforming of the resilient member.

In some forms, the lock body includes a bore extending transverse to the lock body axis, and wherein the at least one latch is disposed in the bore. In some forms, the latch is movable within the bore to allow movement of the detent.

In some forms, the bore is a blind hole and the latch is located within the blind hole such that the detent is disposed at the opening of the bore. In some forms, the detent is arranged to project from the bore when the resilient member is in an undeformed state and is able to retract inwardly when the resilient member is compressed.

In some forms, the bore has first and second openings angularly spaced around the lock body axis. In some forms, the at least one latch includes two detents which are arranged to project from respective ones of the first and second openings.

In some forms, the resilient member is disposed between the detents and deforming of the resilient member varies the spacing between the detents. In some forms, the length of the latch between the detents is greater than the length of the bore when the resilient member is in its neutral, undeformed state.

In some forms, the latch is movable through the bore between the first and second openings.

In some forms, the lock body comprises a body region incorporating a component of an engaging structure on an exterior surface thereof which is arranged to engage with a complementary component of the engaging structure disposed on an interior wall defining at least part of the locking hole, the engaging structure being at least part of a retaining arrangement operative to resist movement of the lock in the wear member under loading in the direction of the lock body axis.

In some forms the engaging structure is helical, or part helical. In this way the lock may be axially advanced or retracted in the locking hole, whilst the components of the engaging structure is engaged, by rotation of the lock body. In some forms, the body region terminates at a second end region of the lock body, and the second end region includes a drive arrangement to receive a tool to impart rotation to the lock body.

In some forms, the engaging structure is operative to resist movement of the lock in the wear member under loading in the direction of the lock axis.

In some forms, the retaining arrangement is operative to resist axial movement of the lock body by the combined operation of the latch and the engaging structure, the latch being operative to provide torsional resistance to the lock body in the locking hole and the engaging structure operative to inhibit axial movement of the lock body when the lock body is restrained from rotating in the locking hole.

In some forms, the engaging structure is helical or part helical and has a pitch that is quite steep to promote rotation and axial movement of the lock body under loading on the lock body in the direction of the lock body axis.

In some forms, where the engaging structure is operative to resist movement of the lock in the wear member under loading in the direction of the lock axis, the pitch is quite flat.

In some forms, the body region is generally cylindrical and the engaging structure is recessed into the body. In some forms, the latch is disposed on the body region. In some forms, the first end region tapers towards the first end of the lock body.

In some forms, the latch and the engaging structure are configured and positioned relative to each other such that the latch does not cross the complementary component of the engaging structure on the inner wall of the wear member on operation of the lock.

Also disclosed is a lock for securing a wear member to a support structure, the wear member having a body that incorporates a cavity configured to receive the support structure, and a locking hole extending to the cavity, the lock being arranged to be movable within the locking hole and comprising: a lock body extending along a lock body axis and having a first end region for engaging with the support structure to allow securing of the wear member with the support structure; and a retaining arrangement operative to resist movement of the lock in the wear member under loading in the direction of the lock body axis, the retaining arrangement comprising: an a component of an engaging structure on an exterior surface of the lock body which is arranged to engage with a complementary component of the engaging structure disposed on an interior wall defining at least part of the locking hole, and one or more retainers operative to provide torsional resistance of the lock body in the locking hole, wherein the engaging structure is operative to inhibit axial movement of the lock body when the lock body is restrained from rotating in the locking hole.

The locking hole may extend from the exterior of the wear member body to the cavity.

In some forms, the at least one retainer is in the form of the latch as described above. In other forms, the at least one retainer is a separate component that may be installed in the locking hole and may be in the form of a compressible member, collar, clip, sleeve or the like, or combination thereof, that provides rotational resistance to the lock body.

In some forms, the separate retainer is in the form of a compressible member that is arranged to apply a bias to the lock body in a direction that is transverse to the lock axis.

In some forms, the separate retainer is in the form of a compressible member that is arranged to at least partially surround the lock body and applies a radial force that is exerted over at least a substantial portion of the circumference of the lock body.

In some forms, a plurality of retainers are provided, for example a latch as described above and a separate retainer.

In some forms, the plurality of retainers are arranged to be angularly spaced apart about the lock body axis when the lock is in a locked position. In some forms, a first retainer is arranged to be disposed at an angle of between 75 and 115 degrees to a second retainer and preferably substantially at right angles.

Also disclosed is a lock for securing a wear member to a support structure, the wear member having a body that incorporates a cavity configured to receive the support structure, and a locking hole extending in the body to the cavity, the lock being arranged to be movable within the locking hole and comprising: a lock body extending along a lock body axis and having a first end region for engaging with the support structure to allow securing of the wear member with the support structure; and a retaining arrangement operative to resist movement of the lock in the wear member, the retaining arrangement comprising a plurality of retainers angularly spaced apart about the lock body axis when the lock is in a locked position.

In some forms, a separate retainer is provided and includes a resilient member that is arranged to compress under load. In some forms, the separate retainer is arranged to bear against the lock body to resist pivoting of the lock body in the locking hole which may otherwise occur under operational load. In some forms, the separate retainer provides some shock absorbing capability to the lock body when installed. This shock absorbing capability may be in addition to, or instead of, the torsional resistance required as part of the retaining arrangement.

Also disclosed is a lock for securing a wear member to a support structure, the wear member having a body that incorporates a cavity configured to receive the support structure, and a locking hole extending in the body to the cavity, the lock being arranged to be movable within the locking hole and comprising: a lock body extending along a lock body axis and having a first end region for engaging with the support structure to allow securing of the wear member with the support structure; and a retaining arrangement operative to resist lateral movement of the lock body within the locking hole.

In some forms, the retainer is formed at least in part as a resilient member that provides a damping force to the lock body to resist lateral movement.

In some forms, the lateral movement is translation of the lock body within the locking hole and/or pivoting of the lock body in the locking hole.

Also disclosed is a wear member for attaching to a support structure of earth working equipment, the wear member comprising a body comprising a first end, an opposite second end that incorporates a cavity configured to receive the support structure, and a locking hole extending in the body to the cavity, the locking hole being arranged to receive a lock to secure the wear member to the support structure and being defined by an interior wall surface that incorporates at least one component of an engaging structure arranged to engage with a complementary component of the engaging structure disposed on an exterior surface of the lock.

The locking hole may extend from the exterior of the wear member to the cavity.

In some forms, the component of the engaging structure is formed as one or more ribs that projects into the locking hole. In some forms the engaging structure is helical, or part helical. The engaging structure may be continuous or may be formed of spaced components that track the helical path.

In some forms, the interior wall surface further comprising at least one notch operative to receive a detent on the lock to inhibit rotation of the lock in the locking hole. In some forms, this notch (or at least one of a plurality of notches if there is more than one corresponding detent on the latch) is located to correspond to a position wherein the lock is in engagement with the support structure to secure the wear member to that support structure. In some forms, the interior wall surface may comprise two or more notches which are spaced apart in the direction of the hole axis and which are arranged to engage with one or more detents of the lock to inhibit the rotation of the lock when the lock is in two or more discrete positions within the wear member.

Alternatively, in some forms, the interior wall surface comprises one or more detents or other latching structures to inter-engage with a complementary latching structure of the lock to locate the lock in one or a plurality of positions in locking hole. These positions may correspond to any of a locking, retracted and transport position.

In some forms, the interior wall surface further comprises a channel that terminates at the exterior surface of the wear member and is arranged to facilitate installation of the lock into the wear member.

In some forms, the interior wall surface further comprises at least one holding formation adjacent the exterior surface of the wear member and is arranged to receive a complementary engaging formation of a holder that is arranged to inhibit release of the lock body from the locking hole.

In some forms, the at least one holding formation is in the form of a re-entrant surface.

In some forms, the interior wall surface forms part of a lock receiving arrangement that includes and the locking hole and further comprises a lock cavity to receive a retainer to provide resistance to the lock body, preferably torsional resistance. In some forms, the lock cavity is in the form of a slot that extends from the locking hole in a direction that is transverse (radial) to an axis of locking hole.

Also disclosed is a wear member for attaching to a support structure of earth working equipment, the wear member comprising a body comprising a first end, an opposite second end that incorporates a cavity configured to receive the support structure, and a lock receiving arrangement defined by an interior wall surface that comprises a locking hole extending along a lock axis in the body to the cavity, and a lock cavity that extends from the locking hole transverse to the lock axis, the locking hole being arranged to receive a lock body to secure the wear member to the support structure.

In some forms, the lock cavity is arranged to receive a retainer for engaging with the lock body.

In some forms, the lock includes a latch that is mountable to the lock body and the lock cavity is arranged to provide an access to facilitate installation of the latch in the lock body when disposed in the locking hole.

In some forms, the slot is multi-purpose and arranged to facilitate installation of the latch in the lock body and to receive a separate retainer for engaging with the lock body.

In some forms, the lock body is rotatable in the locking hole. In some forms, the lock receiving arrangement further comprises at least one component of an engaging structure arranged to engage with a complementary component of the engaging structure disposed on an exterior surface of the lock body.

In some forms, the interior wall surface of the locking hole is formed from the wear member. In one form, the interior wall is cast with the appropriate profile on casting of the wear member. However, if need be, the profile may be finished in a post casting process such as milling or the like.

Alternatively, or in addition, least part of the interior wall surface is formed on an insert locatable in the locking hole. The insert may be cast into the wear member (if that member is cast), or may be mechanically secured through welding or other fixings, or may otherwise be captured in position (for example by being locatable in place from within the cavity and thereby captured in place when mounted onto the support structure).

In some forms, the wear member is formed as a casting and at least a portion of the interior wall defining the locking hole, or a component disposed with that locking hole, is formed from an insert cast into the wear member.

In some forms, the component formed from the cast insert is the component of the at least one engaging structure. In one form, the cast insert may form at least part of a retainer that is arranged to engage with and apply a torsional resistance to a lock body of a lock locatable within the locking hole.

Also disclosed is a cast wear member for attaching to a support structure of earth working equipment, the wear member comprising a body comprising a first end, an opposite second end that incorporates a cavity configured to receive the support structure, and a lock receiving arrangement defined by an interior wall surface that is arranged to receive a lock for securing the wear member to the support structure, wherein at least a portion of the interior wall defining the lock receiving arrangement, or a component disposed with that arrangement, is formed from an insert cast into the wear member.

According to a further aspect, there is disclosed a wear member assembly for attaching to a support structure of earth working equipment comprising: a wear member comprising a body having a first end, an opposite second end that incorporates a cavity configured to receive the support structure, and a locking hole extending in the body to the cavity; and a lock for securing the wear member to a support structure and being arranged to be movable within the locking hole.

In some forms, the lock has a first end region for engaging with the support structure to allow securing of the wear member with the support structure.

The locking hole may extend from the exterior of the wear member to the cavity.

In some forms, a component of an engaging structure is provided on an exterior surface of the lock and a complementary component of the engaging structure is disposed on an interior wall defining at least part of the locking hole, the engaging structure forming at least part of a retaining arrangement operative to resist movement of the lock in the wear member under loading in the direction of the hole axis. In some forms, the engaging structure provides the primary retention arrangement of the locking arrangement to resist any axial loading induced on the lock body which may cause the lock body to be ejected from the locking hole or disengage from the support structure.

In some forms, the engaging structure is helical, or part helical. In this way the lock may be axially advanced or retracted in the locking hole, whilst the engaging structure is engaged, by rotation of the lock body.

In some forms, the retaining arrangement further comprising at least one retainer to restrain movement of the lock in the wear member when the engaging structure is in engagement.

In some forms, the retaining arrangement is operative to resist axial movement of the lock body by the combined operation of the retainer and the engaging structure, the retainer being operative to provide torsional resistance of the lock body in the locking hole and the engaging structure operative to inhibit axial movement of the lock body when the lock body is restrained from rotating in the locking hole.

In some form, the wear member assembly further comprises a latch arrangement to restrain movement of the lock in the wear member when the engaging structure is in engagement. In some forms, the latch arrangement is arranged to inhibit rotation of the lock when the lock is disposed in one or more positions. Further the latch arrangement may provide more general frictional resistance to rotation outside these one or more positions to prevent play in the lock and to allow more controlled movement of the lock in the locking hole.

In some forms, the latch arrangement functions as the retainer of the retaining arrangement. In some forms, the latch and retainer may be separate components.

In some forms, a plurality of retainers are provided. One retainer may be in the form of a latch arrangement. In some forms, a further latch arrangement may be provided.

In some forms, a separate retainer is provided and includes a resilient member that is arranged to compress under load. In some forms, the separate retainer is arranged to bear against the lock body to resist lateral movement (being translation and or pivoting of the lock body in the locking hole) which may otherwise occur under operational load. In some forms, the separate retainer provides some shock absorbing capability to the lock body when installed. This shock absorbing capability may be in addition to, or instead of, the torsional resistance required as part of the retaining arrangement.

In some forms, the plurality of retainers are arranged to be angularly spaced apart about the lock body axis when the lock is in a locked position. In some forms, a first retainer is arranged to be disposed at an angle of between 75 and 115 degrees to a second retainer and preferably substantially at right angles.

In some forms, the wear assembly further comprises a holder to secure the lock to the wear member independently of the engaging structures. In some forms, the holder is frangible and therefore single use. In other forms, the holder may remain intact, in either an active, or inactive state, throughout the movement of the lock in the locking hole.

In some forms, the lock is secured to the wear member in a transport position where the combination of the wear member and lock is arranged to be provided to site. In some forms, when in the transport position, the lock is positioned so as to allow the wear member to be installed on the support member. In other forms, when in the transport position, the first end region extends into the cavity and prevents installation of the wear member onto the support structure. In this later form, the lock needs to be moved from the transport position to allow for installation.

In some forms, the holder is arranged to secure the lock to the wear member in the transport position.

In some forms, the wear member assembly is arranged such that when in the transport position, the first end region extends into the cavity and prevents installation of the wear member onto the support structure. In some forms, the holder permits sufficient movement of the lock in the locking hole to enable movement of the lock from the transport position to a position where the first end region of the lock is sufficiently clear of the cavity to permit installation of the wear member onto the support structure.

In some forms, where the above transport position is provided, the first end region may include an angled, or camming surface that under the application of a force to that surface in a direction normal to the axis of the hole, the lock is biased to retract into the locking hole.

In some forms, the lock and the wear member have respective bearing surfaces that are in opposing relation when the lock is in a locked position, the bearing surfaces being arranged to be angularly offset from one another when the wear assembly is not under loaded conditions. In some forms, when in loaded condition, the lock body is biased to move relative to the wear member to cause the opposing bearing surfaces to move to reduce the angular offset so as to provided increased surface engagement between the bearing surfaces.

According to a further aspect, there is disclosed a wear member assembly for attaching to a support structure of earth working equipment comprising: a wear member comprising a body having a first end, an opposite second end that incorporates a cavity configured to receive the support structure, and a locking hole extending in the body to the cavity; and a lock for securing the wear member to a support structure and being arranged to be movable within the locking hole to a locked position, the lock and the wear member have respective bearing surfaces that are in opposing relation when the lock is in the locked position, the bearing surfaces being arranged to be angularly offset from one another when the wear assembly is not under loaded conditions and arranged, under in-use loading conditions, to be biased to move to reduce the angular offset so as to provided increased surface engagement between the bearing surfaces under the in-use loading conditions.

The wear assembly as described in any form above may include any of the forms of lock or wear member as described in the first and second aspects above.

In a further aspect, there is disclosed a method of assembling a wear member onto a support structure of earth working equipment, the method comprising: providing the wear member as part of a wear member assembly incorporating the wear member and a lock secured to the wear member, the lock being disposed in a locking hole formed in the wear member in a transport position where a first end region of the lock projects into a cavity of the wear member shaped to receive the support structure and; mounting the wear member onto the support structure so that the support structure is received into the cavity; and causing the support structure to engage the lock during the mounting, and wherein under continued movement of the wear member onto the support structure, the lock is caused to retract into the locking hole so that the wear member can be fully mounted onto the support structure.

In a further aspect, there is disclosed a method of installing a lock into a wear member of earth working equipment comprising: providing the wear member with a lock receiving arrangement comprising a locking hole and a lock cavity projecting from the locking hole; installing a lock body of the lock into the locking hole; subsequently mounting a first retainer into the lock body installed in the locking hole via the cavity; and installing a second retainer into the lock cavity.

The present disclosure relates generally to locks, wear members and wear assemblies. In some embodiments, the wear member is secured to the support structure that is fixed to a bucket lip or other digging edge. The support structure may be part of an adapter or may be integrally formed to the digging edge. However, it is understood that embodiments of the present disclosure may be applied to excavation tooth assemblies in which the wear member is mounted to an intermediate member (which may also be referred to as a support structure or an adapter) that in turn is mounted to a nose that forms part of the digging edge or to the nose of a further support structure that is mounted to the digging edge. In the present disclosure, locking assemblies are used to secure the wear member to the support structure, however, the locking assemblies disclosed herein may also be used to secure any member that makes up the excavation wear assemblies to one another. Accordingly, the wear member in that arrangement might be an intermediate member which in turn locates within a further member which is exposed to wear.

### BRIEF DESCRIPTION OF THE FIGURES

Embodiments will now be described by way of example only, with reference to the accompanying drawings in which

FIGS. 1a and 1b are perspective views of an embodiment of an excavation wear assembly, where the lock is in the transport position and in an extended position respectively;

FIG. 2 is a sectional view of the embodiment of the excavation wear assembly of FIG. 1;

FIG. 3 is a close-up sectional view of FIG. 2 through A-A;

FIGS. 4a and 4b are front and rear isometric views of an embodiment of a locking assembly for the excavation wear assembly respectively;

FIG. 5 is a sectional view of the embodiment of the excavation wear assembly of FIG. 1, where the lock is in the transport position;

FIG. 6 is a sectional view of the embodiment of the excavation wear assembly of FIG. 1, where the lock is in an extended position;

FIGS. 7a to 7j are a sequence of sectional views of the embodiment of the excavation wear assembly of FIG. 1 showing the installation of the lock body from a transport position to an extended position;

FIGS. 8a, 8b and 8c are plan views detailing the embodiment of the locking assembly for the excavation wear assembly of FIG. 1;

FIG. 8d is a side view detailing the embodiment of the locking assembly for the excavation wear assembly of FIG. 1;

FIG. 9 is a detailed sectional view of the embodiment of a locking assembly for the excavation wear assembly of FIG. 1;

FIGS. 10a and 10b are isometric views of an embodiment of a locking assembly for an excavation wear assembly;

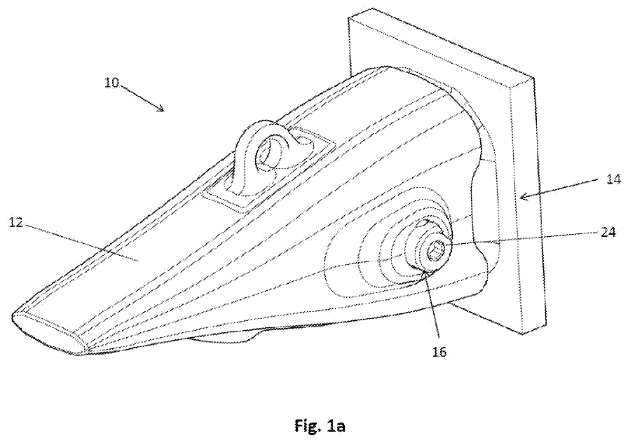

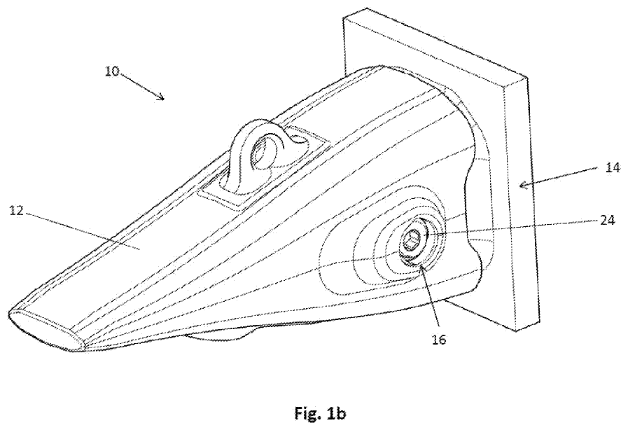

FIGS. 1 la and l lb are respectively, an isometric view and a sectional side view of an embodiment of a locking assembly for an excavation wear assembly;

FIGS. 12a, 12b and 12c are sectional side views of an embodiment of a locking assembly for an excavation wear assembly;

FIGS. 13a and 13b are isometric views of an embodiment of a locking assembly for an excavation wear assembly;

FIGS. 14a, 14b and 14c are isometric views of an embodiment of a locking assembly for an excavation wear assembly.

FIGS. 15a and 15b are an isometric view and a close-up side view, respectively, of an embodiment of a locking assembly for an excavation wear assembly.

FIG. 15c is an isometric view of an embodiment of a locking assembly for an excavation wear assembly.

FIGS. 16a to 16d are isometric views of the components of a further embodiment of locking assembly;

FIGS. 16e to 16g are various views of the locking assembly of FIGS. 16a to 16d installed in a wear member;

FIGS. 16h and 16i are schematic views of the lock receiving arrangement in the wear member for the locking assembly of FIGS. 16a to 16d;

FIGS. 16j and 16k are schematic views of variations of the lock receiving arrangement in the wear member for the locking assembly of FIGS. 16a to 16d;

FIG. 161 is a section view of a variation of the lock assembly of FIGS. 16 to 16d;.

FIGS. 17a to 17c are isometric views of the components of a further embodiment of locking assembly;

FIGS. 17d and 17e are sectional views of the locking assembly of FIGS. 17a to 17c installed in a transport and locked position respectively;

FIG. 17f is transverse sectional view along section line A-A of FIG. 17e;

FIG. 17g is a schematic view of the locking assembly of FIGS. 17a to 17c in the locked position;

FIGS. 18a and 18b are sectional views of the locking assembly of FIGS. 16a to 16d installed in a locked position and in an unloaded and loaded condition respectively; FIG. 18c is the sectional view of FIG. 18a showing loading conditions on the lock body;

FIGS. 19a is an isometric view of the wear member that includes the lock receiving arrangement of FIGS. 16h and 16i, where the lock receiving arrangement is formed from an insert cast into the wear member;

FIGS. 19b to 19e are sectional views of the lock receiving arrangement of FIG. 19a showing variations of the keying structure to key the insert to the cast wear member;

FIGS. 20a to 20d show various views of a variation of the lock assembly of FIGS. 16a to 16i where the second retainer is a resilient collar;

FIGS. 21a to 21e is an installation sequence (showing both section and exterior views) of a lock assembly being a variation of the lock assembly of FIGS. 16a to 16i; and

FIGS. 21f to 21i is an installation sequence of the wear assembly of FIGS. 21a to 21e onto a support structure.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

The present disclosure relates generally to wear assemblies for digging equipment. In the illustrated embodiment, an excavation wear assembly is shown comprising a wear member that is mounted to a nose portion of a support structure that is fixed to a bucket lip or other digging edge. The nose portion may be part may be integrally formed with the bucket lip. However, it is to be understood that embodiments of the present disclosure could be applied to excavation wear assemblies in which the wear member is mounted to an intermediate member such as an adapter (which may also be referred to as a support structure) that in turn is releasably mounted to a nose that forms part of the digging edge. Further the wear member may form the external surface of the wear assembly or may constitute the intermediate member and therefore provide the nose to receive a further wear member. In the excavation wear assemblies of the present disclosure, a lock is used to lock the wear member to the nose of the support structure or the nose integrally formed with the digging edge. Similarly, in excavation wear assemblies comprising an intermediate member, locks are used to lock the outermost wear member (point) to the intermediate member and the intermediate member to the nose formed with the digging edge or of a tooth member attached to the digging edge.

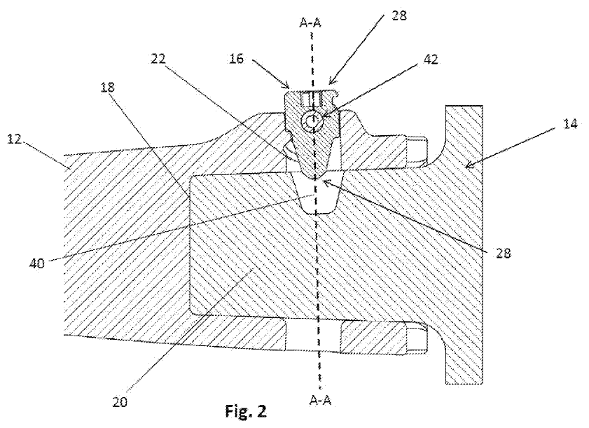

Referring to FIGS. 1A, 1B and 2, there is shown a wear assembly 10, comprising a wear member 12 mountable to a support structure 14, and a lock 16. Referring specifically to FIG. 2, the wear member 12 has a cavity or socket 18 (best shown in FIG. 2), and the support structure 14 has a nose portion 20. The lock 16 includes a lock body 24 in the form of a locking pin. The locking pin 24 is inserted into a locking hole 22 formed in the wear member 12 and in one form, is disposed in place prior to mounting the wear member 12 to the support structure 14. In this way the wear member may be provided with the lock pre-installed. Various approaches to secure the lock to the wear member are disclosed below. The socket 18 of the wear member 12 is configured to receive the nose portion 20 of the support structure 14 when the wear member 12 and the support structure 14 are brought together as shown in FIG. 2. In use, the support structure 14 is attached to a digging edge or lip of excavation equipment (not shown), and the wear member 12 includes the wear surface and edge which does the digging.

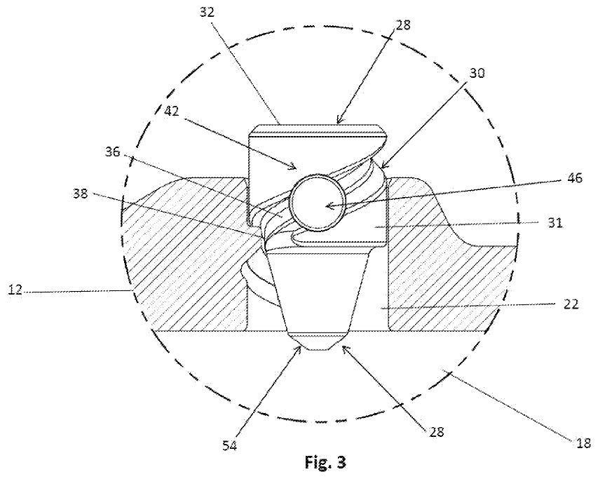

The lock 16 is arranged and designed to secure the wear member 12 to the support structure 14. As best shown in FIG. 3, the locking pin 24 extends along a pin axis and includes a first end 26 and a second end 28 that are spaced apart along the pin axis by a component 36 of an engaging structure 30, which in the illustrated form is formed as a recess on a body portion 31 of the pin 24.

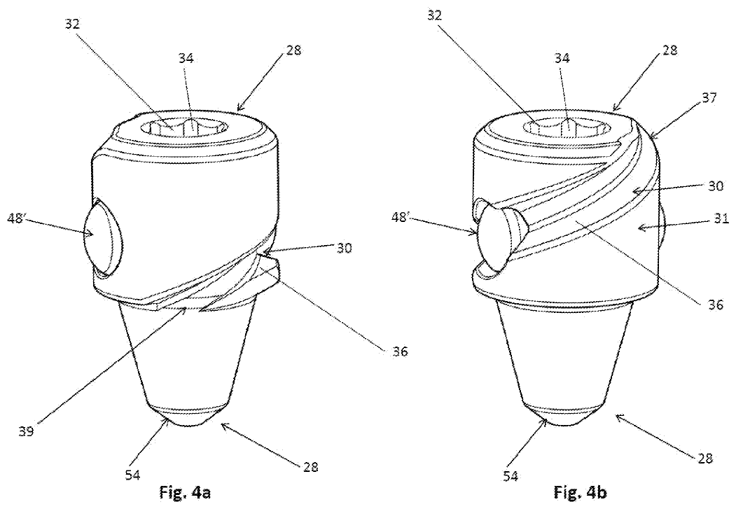

The second end 28 comprises a drive arrangement 32. In the illustrated embodiment of FIGS. 4A and 4B, the drive arrangement 32 in the form of a hexagonal recess 34 is provided in the second end of the locking pin to enable an operator to cause rotation of the locking pin 24 as required. This is carried out by the operator inserting an appropriately shaped tool into the recess 34. The manner in which the locking pin 24 is inserted into the locking hole 22, means that after it has been inserted, the hexagonal recess 34 remains exposed at the end of the locking space. This allows for easy access to the recess 34 for access to the drive arrangement 32 and for removal of the locking pin 24 from the locking hole 22 when required. However, it is to be appreciated that other forms of drive arrangements, including male drives, may be used.

The first end 26 of the pin 24 is configured as a leading end of the pin. As shown in FIG. 3, the leading end 26 comprises a taper which allows it to be extended and retracted more easily through the locking hole 22 if surrounded by fines.

The component 36 of engaging structure 30 engages with a complementary component 38 of the engaging structure 30 formed on an interior surface of the locking hole and causes axial movement of the pin 24 relative to the wear member 12 on rotation of the pin. As shown in FIGS. 3 and 4, the engaging structure30 is a helical arrangement, formed as a part or full helix (i.e. it extends at least 360 degrees). The helical arrangement includes a pitch which corresponds to the number of rotations of the pin 24 to establish the desired axial displacement. Varying the pitch of the helical arrangement varies the rate of the axial displacement of the pin for a given rotation as well as the resisting force imparted by the engaging structure 30 to resist axial movement under the application of an axial load being applied to the locking pin 24. The locking hole 22 of the wear member 12 comprises a corresponding helical arrangement 38 as its component of the engaging structure 30 as to engage with that of the pin 24.

The engaging structures 30 forms at least part of a retaining arrangement to inhibit axial movement of the locking pin on the application of axial loading to pin (which prevents inadvertent release of the pin in use). In some forms, this may be achieved by having a relatively flat pitch such that axial loading is resisted solely by the engaging structure. However, in the illustrated form, the pitch of the helical arrangement is quite steep so that axial loading to the pin promotes rotational and therefore axial drive to the pin. In this way, the retaining arrangement further comprises a retainer (in one form comprising a latching arrangement 42 disclosed below) to provide torsional resistance to rotation of the pin such that the combined operation of the helical arrangement and torsional resistance from the retainer inhibit axial movement of the pin under axial loading to the pin. This allows for a more controlled mechanism to resist axial movement (as it is possible to more finely control the torsional resistance) and allows the engaging structure to be directly cast into the wear member (as a more precise thread is not required).

The helical arrangement 36 of the engaging structure 30 extends over the surface of a body portion 31 of the pin between the drive arrangement 32 and the leading end 26, helically relative to the pin axis of the locking pin 24. In the form as illustrated, the helical arrangement of the engaging structure 30 comprises respective recesses or grooves 36 and ribs or ridges 38. The helical groove 36 has both upper 37 and lower 39 openings. In one form, the lower opening 39 is shaped to allow any fines that have collected in the groove 36 to exit uninhibited from the wear assembly 10 when the pin 24 is rotated, for example towards the retracted position. This shaping is provided by a radial reduction of the lower wall that defines the groove. This creates a space (as best shown in FIG. 3) between the pin and the ridge 38 that allows the fines to drop out from the groove.

In the form shown, the ridge 38 on the wear member is continuous but it is appreciated that it could be in spaced sections that trace the helical path. The helical groove 36 extends approximately 360°, i.e. one revolution, from the drive arrangement 32 of the pin towards the leading end 26.

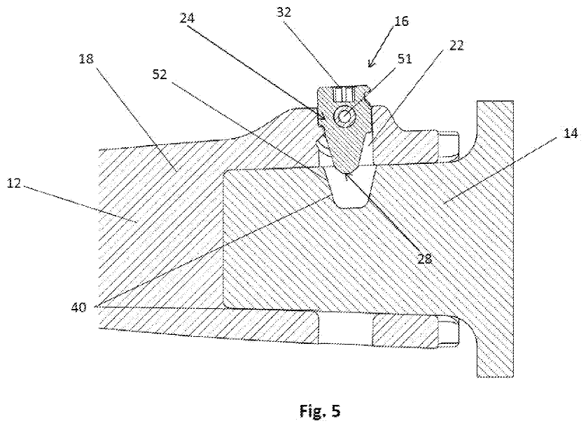

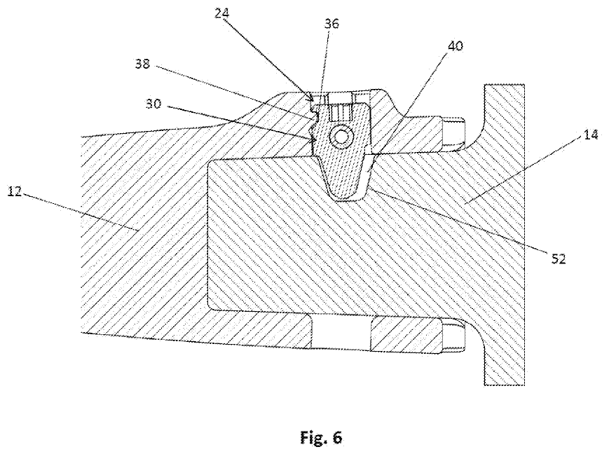

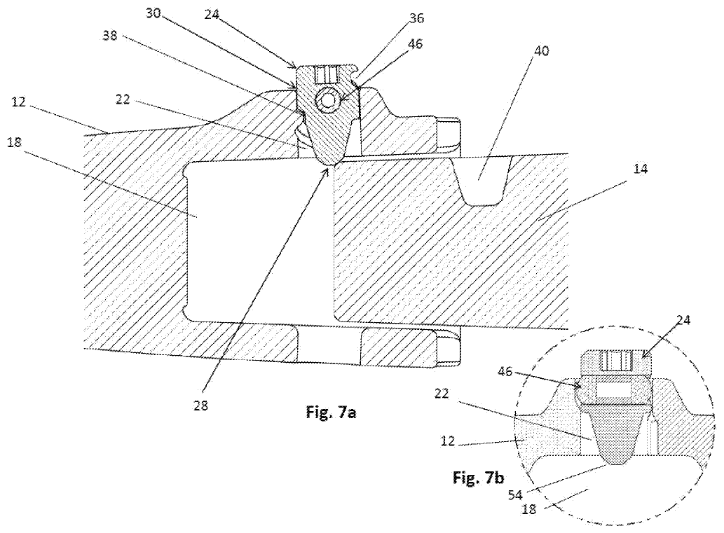

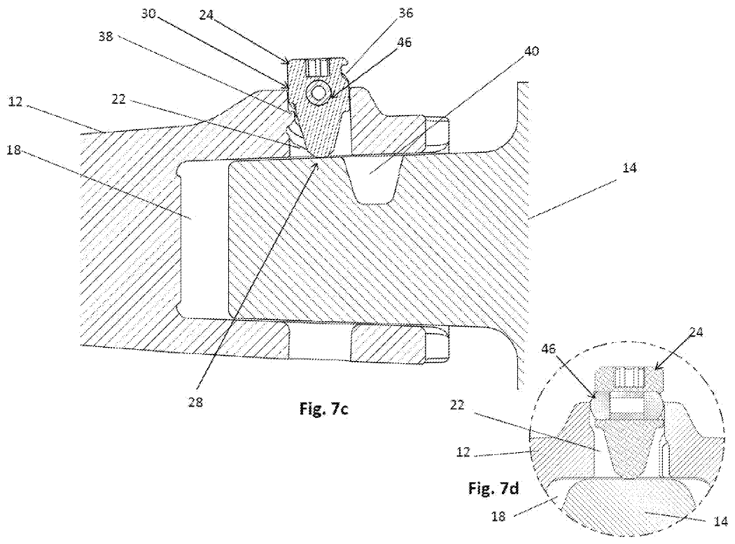

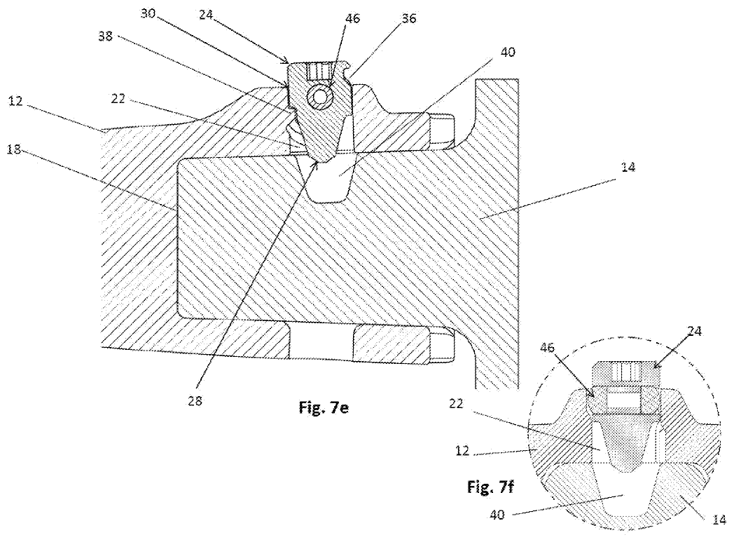

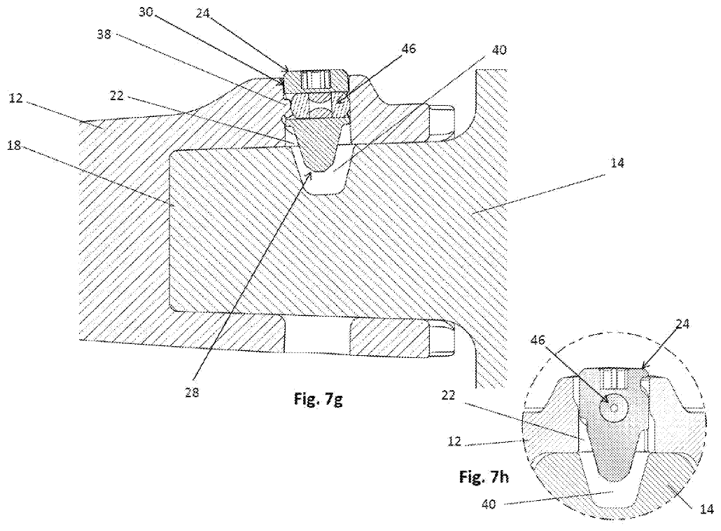

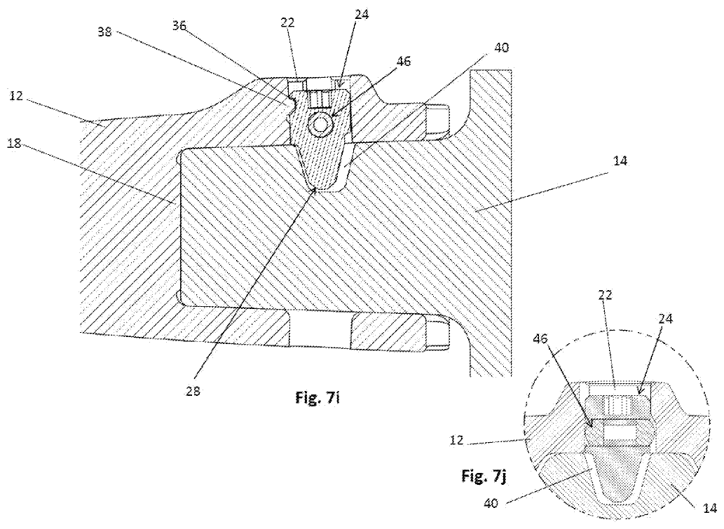

Referring now to FIGS. 5 and 6 and the sequence of FIGS. 7a to 7j. In some forms, the locking pin 24 is axially movable along the helical arrangement 30 between a retracted position (best shown in FIGS. 7c and 7d) and an extended position (FIG. 6). In the retracted position the leading end 26 does not extend into the socket 18 of the wear member 12, i.e. beyond an open end of the locking space 22. In this position, the leading end of the locking pin does not impede the passage of a support structure therethrough.

In the extended position, the leading end of the pin 24 is arranged to extend into the socket 18 when mounted to a support structure. The locking pin extends into a recess 40 of the support structure 14 so as to secure the wear member 12 to the support structure 14.

The helical arrangement 30 may define a start and end locating position for the pin 24. In some embodiments, the start locating position defines the retracted position, whilst the end locating position defines the extended position.

In some forms, the pin may be positioned in a transport position. In that arrangement, the wear member is arranged to be supplied onsite with the lock preinstalled and disposed in the transport position. Whilst this transport position may correspond to the retracted position of the lock or the extended (or locking) position, it may also be a position separate from either of those position as shown in FIG. 5. In the transport position of FIG. 5, the leading end 26 partially extends from the locking hole 22 to encroach into the socket 18. In this discrete position, the locking pin 24 is arranged to prevent the wear member being installed on the support structure. The leading end is arranged so as to interfere with the support structure nose 20 when the wear member 12 is assembled onto the support structure 14. The interference created is best illustrated in the sequence of FIGS. 7a to 7j.

As shown in the sequence illustrated in FIGS. 7a to 7j, in-use, when attempting to install the wear member 12 onto a support structure 14, the leading end 26 of the locking pin would encroach into the wear member socket 18 when in its transport position. The interference of the pin prevents the wear member being installed onto the support structure when the pin is in the transport position. In other words, as the nose 20 of the support structure moves into the wear member socket, the support structure will contact the leading end of the pin. In order to allow the wear member to be fully mounted onto the support structure, the pin must be ‘backed-off’, i.e. moved outwards from the locking hole and away from its transport position and into the retracted position. Once the pin is moved into the retracted position so as to no longer encroach into the wear member socket, the wear member can be allowed to be installed onto the support structure.

This movement may be done manually or may occur as a consequence of fitting the wear member onto the support structure as shown in the sequence of FIGS. 7a to 7j. In particular, the leading end 26 of the pin also comprises a chamfered tip 54. The chamfered tip, when in-use and in one form of the transport position, extends into the socket 18 of the wear member by e.g. 4 mm The chamfered tip encroaches the passage created by the socket and therefore is designed to interfere, i.e. contact with the support structure 14 when inserted therein. Because of the shape of the tip 54, it promotes a cam action on contact with the support structure to promote the desired uplift movement under the application of a transverse force applied to that surface. This causes the pin to be lifted clear and allows the support structure 14 to pass until the pin and the recess 40 in the support structure move into alignment whereafter the pin is able to drop (or otherwise move) into the recess. From this position, the pin can then be driven into an extended position with the support structure.

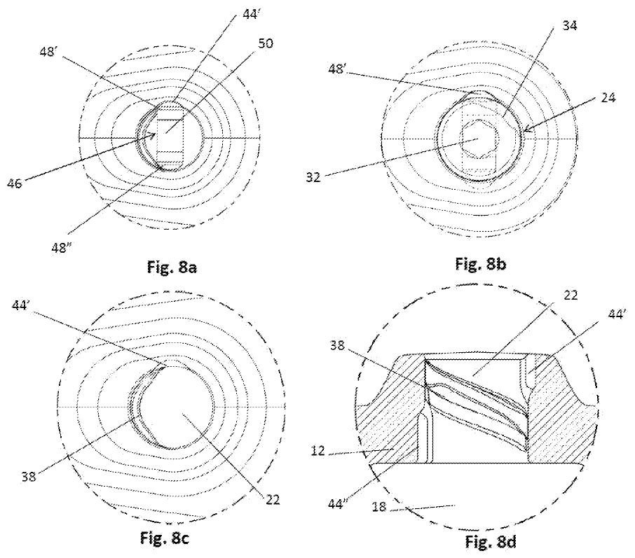

Referring now to FIGS. 2 to 4, the locking assembly 16 further includes a latching arrangement 42. The latching arrangement 42 retains the pin 24 in a predetermined axial position primarily by inhibiting rotation of the pin when the helical engaging structures are engaged. The latching arrangement 42 includes at least one keeper 44, i.e. a locking notch (best shown in FIGS. 8a to 8d), and a latch 46 including one or more detents 48, which are respectively located on the wear member 12 and locking pin 24. In some embodiments, without the latching arrangement 42, the pin 22 can be retained loosely within the helical engaging structures such that the pin 22 can rotate free.

In some forms, such as illustrated, the latching arrangement is also adapted to provide the function of the retainer of the retaining arrangement to provide the torsional resistance to rotation of the locking pin.

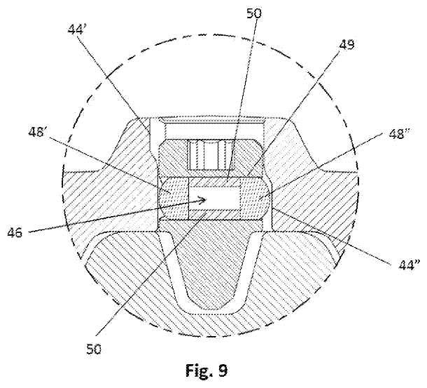

As best shown in the embodiment of FIG. 9, for each lock assembly 16, a latching arrangement 42 may be provided having a latch 46 and two notches 44′ ,44″. In one form, a first of the two keepers is arranged to retain the pin in the transport position shown in FIG. 5 and a second of the two keepers is arranged to retain the pin in the extended position shown in FIG. 9. If required, further keepers may be provided to retain the pin in other positions, such as the retracted position, or one or more further intermediate position between the retracted and extended position.

In the illustrated embodiment of FIG. 9, the latch 46 includes two detents (designated 48′ and 48″), with one detent 48″ being engageable with the keeper 44″ in a latched position to retain the pin in the extended position and the other detent 48′ being engagable with the other keeper 48′ in a latched position to retain the pin in a transport position. The keepers 44′,44″ are formed at opposing ends of the locking hole 22. In the form shown in FIG. 9, the latch 46 includes a biasing member 50 to allow the respective detents 48′.48″ to be depressible to locate in the respective keepers 44′,44″. As shown in the illustrated embodiment of FIGS. 8a, 8b, 8c and 8d, the keeper 44′ includes a recess (in view) and the detent of latch 46 locates in the recess to retain the pin 24 in the predetermined axial position. The detent of the latch is movable against the biasing member 50 to be able to ride past the keeper and move out from the keeper.

In use, the engaging structure 30 causes the pin 24 to rotate as it moves between the retracted, transport and extended position. The keepers 44′, 44″ arranged at opposing ends of the locking hole 22 are able to retain the pin in either of the predetermined transport or extended positions. As best shown in FIGS. 8 and 9, the latch 46 includes the detents 48′ and 48″ at opposites ends and formed from rigid members (forming the detents), and a resilient portion 50 (forming the biasing member) located between the detents. The latch 46 is located within a hole 49, i.e. a through-hole passing through the body portion 31 of the pin 24. In the embodiments shown in FIGS. 1 to 13, the latch 46 is generally cylindrical and the rigid detents 48 are in generally hemispherical that are shaped to locate in the recessed end of the keepers.

A variation of the latch is shown in FIGS. 14a to 14c. The locking assembly 1016 shares many of the features of the earlier embodiments and for convenience, the same reference numerals are used for the same features of earlier embodiments but with the prefix “10”. In the variation of FIGS. 14a to 14c, the latch 1046 is more cuboid that cylindrical having an obround profile. The rigid detents 1048 have a curved outer surface to facilitate location into the keepers. The hole 1049 in the pin 24 and arranged to receive the latch 1046 is of a complementary shape to receive the more cuboid latch 1046. In other respect, the arrangement of FIGS. 14a to 14c functions in the same way as the earlier embodiment.

Turning back to FIG. 9, The rigid detents 48′, 48″ project radially from the hole 49 of the pin such that the hemispherical detents extend from opposing sides of the pin 24 and into the corresponding component 38 of the engaging structure 30 of the locking hole 22. In some forms one, or both, of the opposing detents can project from the groove 36 of the helically shaped engaging structure 30 in the pin 24.

The rigid detents 48′ 48″ of the latch engage with the locking hole 22 such that resilient portion 50 compresses. The resilient portion 50 can comprise concentric layers of elastomeric material positioned in the hole between the rigid detents 48′ 48″. The resilient portion 50 can comprise a hollow core 51. The resilient portion 50 compresses upon engagement of the pin 24 in the locking hole 22. The locking hole 22 does not allow for the resilient portion 50 to expand outwardly when compressed. Instead, the loading induced on the rigid detents 48′ 48″ compress the resilient portion 50 whereby it resiliently expands into the empty space of the hollow core 51.

In a variation, not shown, the through hole 49 in the pin 24 comprises a void that defines a hole or groove along at least one wall surface of the hole 49. In use, the void locates adjacent the resilient portion 50, whereby when the resilient portion 50 is compressed by the rigid detents 48′ 48″ moving inwardly towards each other, the resilient portion 50 is able to expand into the void.

Alternatively, in some variations, the resilient portion may be replaced by any resilient material, such as a spring, also compressible within the hole, or a combination of a spring and compressible material (as discussed below with reference to FIG. 161).

The rigid detents 48′ 48″ are biased by the resilient portion so as to extend into the path of the locking hole 22. In operation, as the helical groove 36 of the pin 24 rotates through the helical ridge38 of the locking hole 22, the rigid portions of the latch mechanism are compressed against the bias of the resilient portions to apply a radial pressure into the locking hole 22 of the wear member 12 such that the pin 24 is resistant to movement through the locking hole. Consequently, the resistance to movement of the pin can require a corresponding torque applied to the drive arrangement 32 in order to rotate the pin 24 between the extended and transport positions.

Advantageously, the radial pressure applied to the locking hole can hold the pin within the locking hole when the helical ridge and groove of the engaging structure are not engaged. This can allow the wear member to be positioned in an inverted orientation without the pin 24 falling from the locking hole because of gravity.

When one of the rigid detents 48′ 48″ of the latch mechanism pass over one of the keepers 44′, 44″, the pin 24 moves into a latched position. In the latched position, the latch 46 may move into an offset position, i.e. is not centred about the pin axis. As shown in FIG. 9, in-use, the offset position is achieved by having one of the opposing detents 48′ 48″ of the pin 24 engaged with one of the keepers 44′ or 44″. In this position, the latch member retains the pin in either of the keepers 44′, 44″ in the respective transport or extended positions. Even with this offset position, the resilient member may still be partially compressed with pressure being applied on the other detent of the latch to the one that is received in the keeper.

In one form, one or both of the keepers 44′, 44″ may each include opposing notches so that both detents 48′ 48″ are received in notches of that keeper. In another form, the respective keepers only include a single notch. The pin may also be arranged to rotate through less than 360 degrees and the notches of the respective keepers are offset radially from each other around the pin axis so that one detent 48′ engages the notch of one keeper 44′ in the transport position and the other detent 48″ engages the notch of the other keeper 48″ in the extended position.

In operation, rotating the pin 24 so as to move the latch member 46 away from engagement with the keeper 44′ or 44″ disengages the rigid detent 48′ 48″ from the keeper. Disengagement from the keeper moves the rigid detent against its bias as it travels away from the keeper and along the groove of the helical ridge of the locking hole.

FIGS. 5 and 6 illustrate the excavation wear assembly 10 including the locking assembly 16 in respective transport and extended positions. In operation, the locking assembly 16 is inserted, i.e. threaded into the locking hole 22 of the wear member 12 prior to the wear member 12 being retained on the support structure 14.

FIG. 5 illustrates the wear member 12 received on the support structure 14 including the locking assembly 16 in the transport position. The wear member 12 and the support structure 14 extend along a longitudinal assembly axis. The lock 16 is retained in a lateral position in the locking hole 22 with respect to the assembly axis of the wear member 12 and the support structure 14.

The recess 40 in the support structure 14 extends into the support structure and is shaped to receive the corresponding leading end 26 of the locking pin 24. In operation, when the wear member is mounted to the support structure, the recess 40 is aligned with the locking hole 22 of the wear member. The tool (not shown) is able to access the drive arrangement 32 of the locking pin 24 to move the locking pin 24 from the transport to the extended position and vice versa.

FIG. 6 illustrates the locking pin 24 in the extended position. In the extended position, the locking pin is able to engage a wall 52 that defines the recess 40 to retain the wear member 12 on the support structure 14. The leading end 26 of the pin includes a bearing surface which engages the wall 52 of the recess 40.

As best shown in FIG. 5, the leading end 26 comprises a taper which allow it to be retracted more easily if surrounded by fines. When the pin 24 is moved from a retracted position to a transport position, or when the pin is rotated from the transport position into the extended position, the taper on the end of the pin 24 in cooperation with the angle of the wall 52 of the recess 40 are able to pull the wear member 12 onto the support structure 14 such that the locking hole 22 and the recess 40 are aligned.

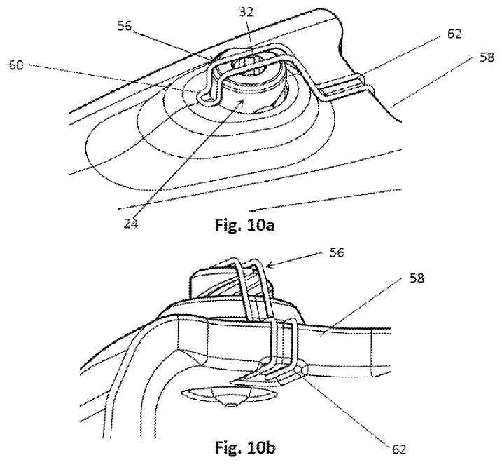

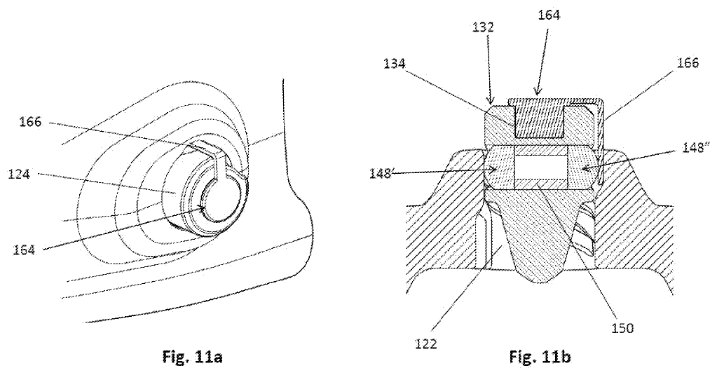

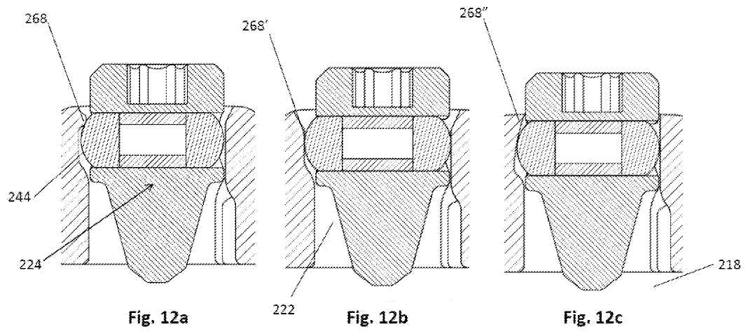

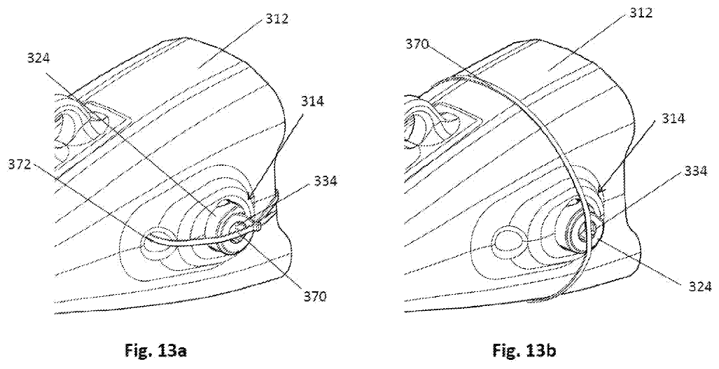

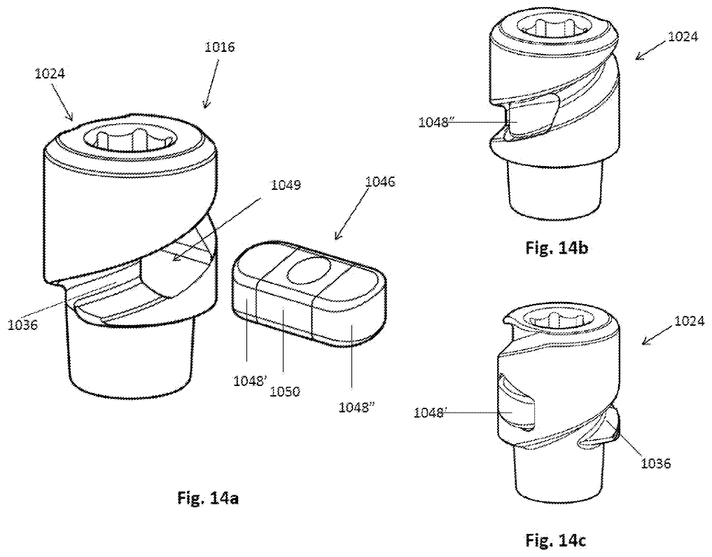

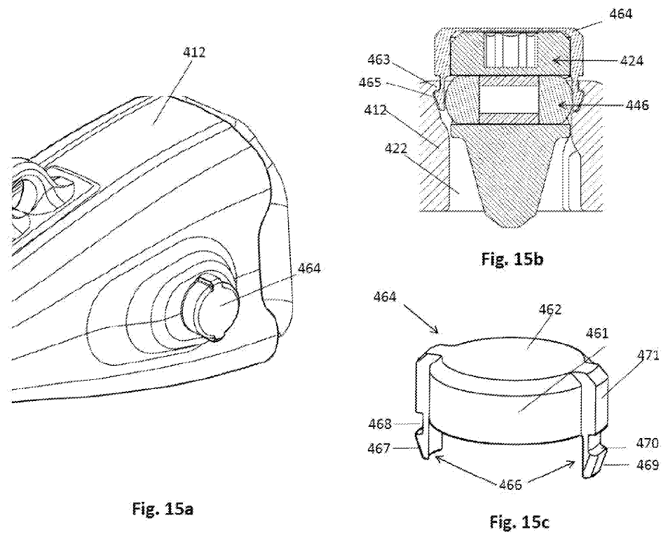

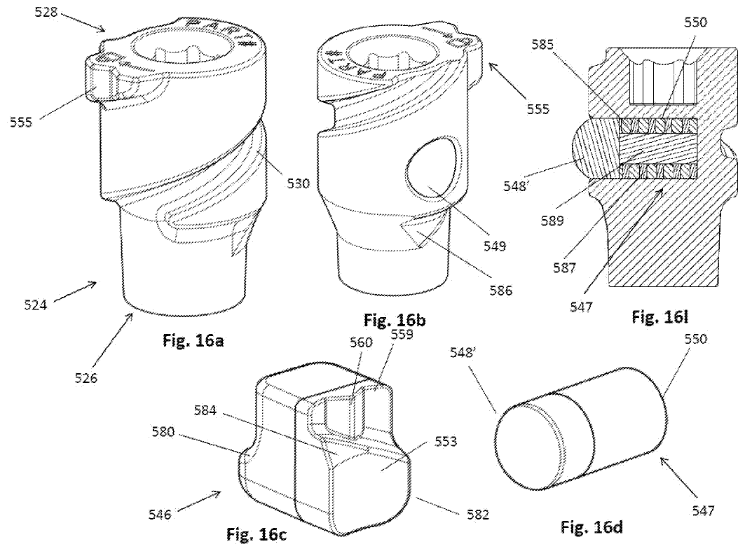

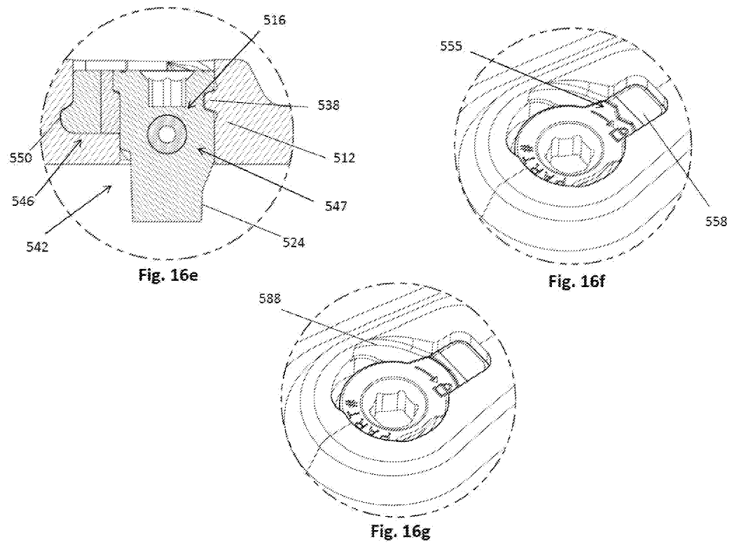

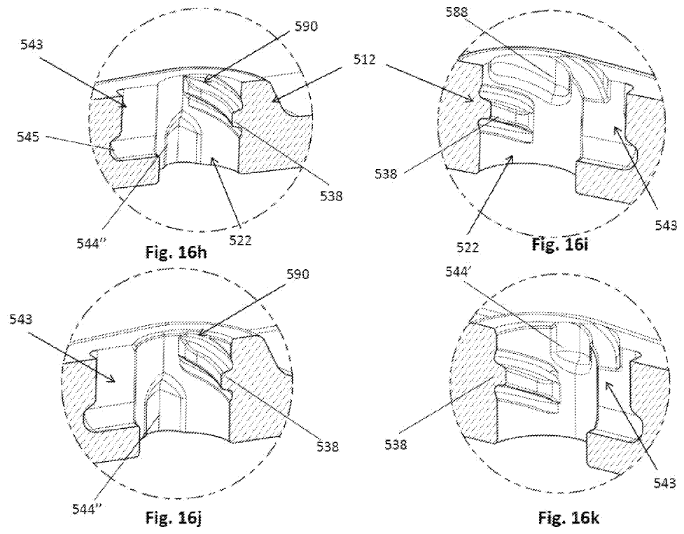

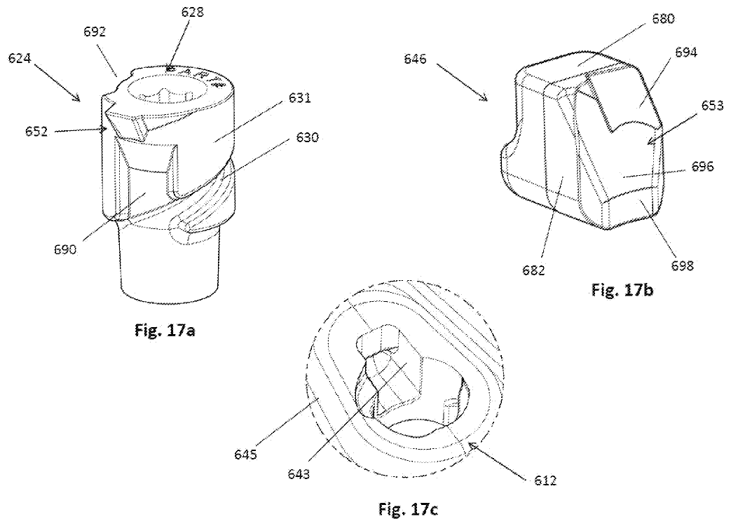

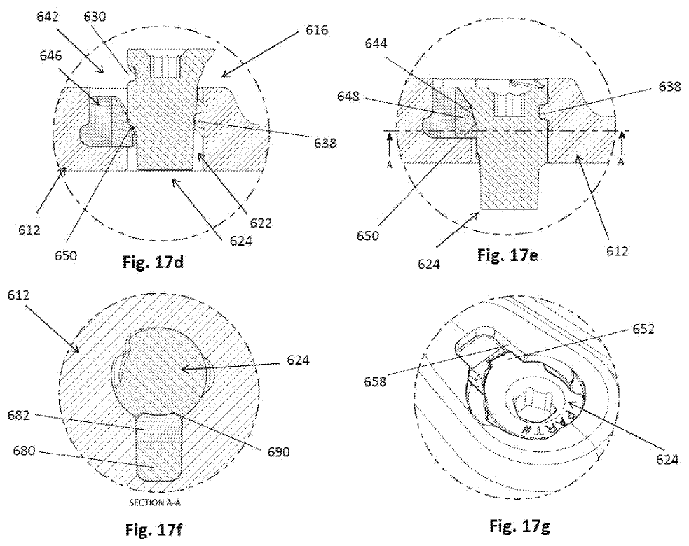

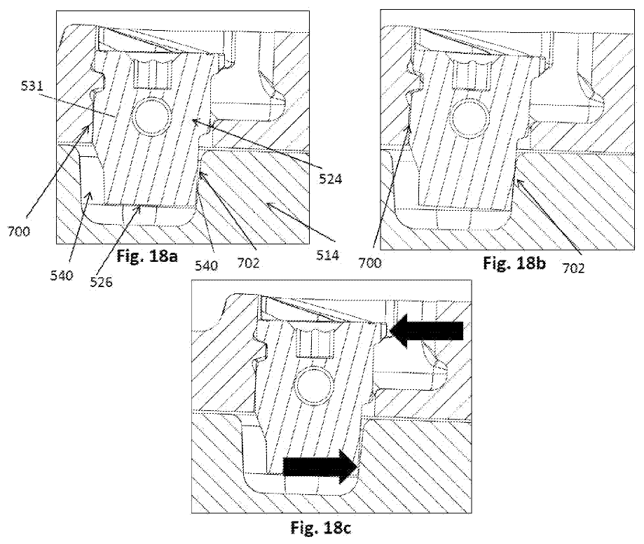

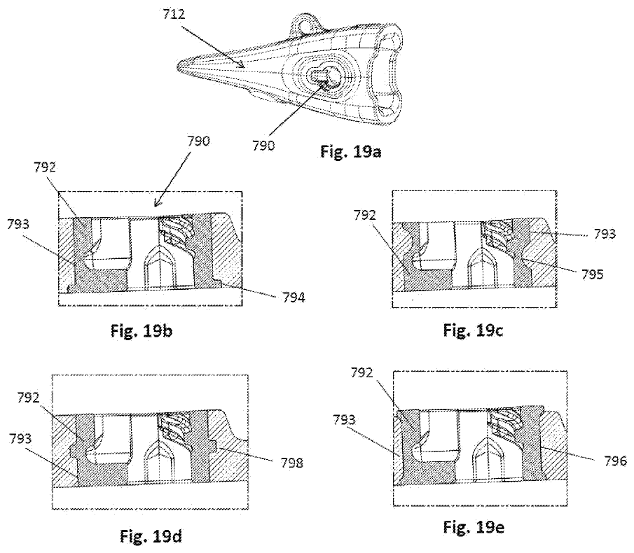

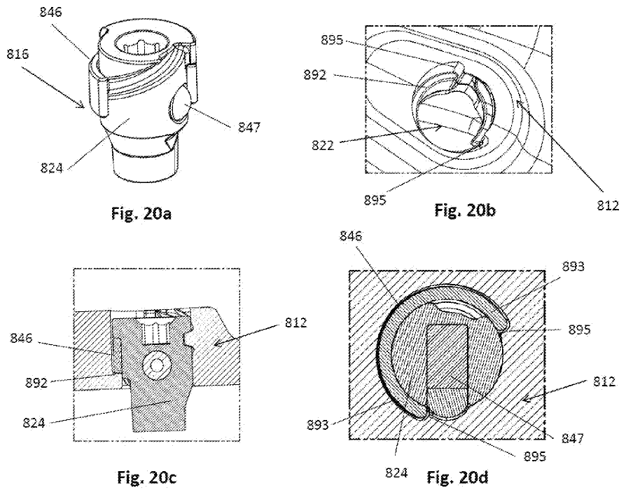

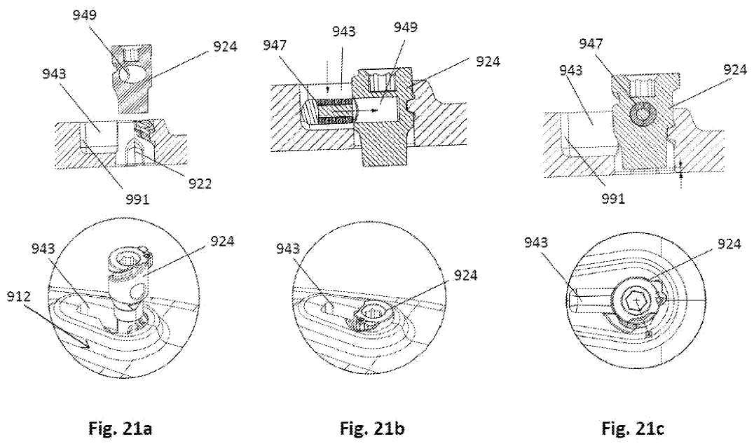

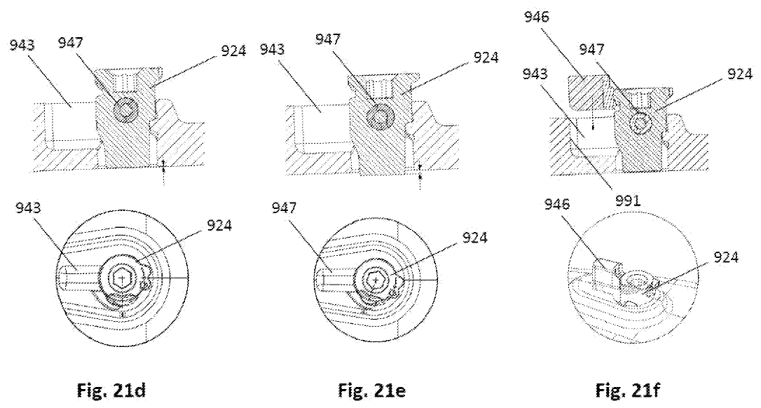

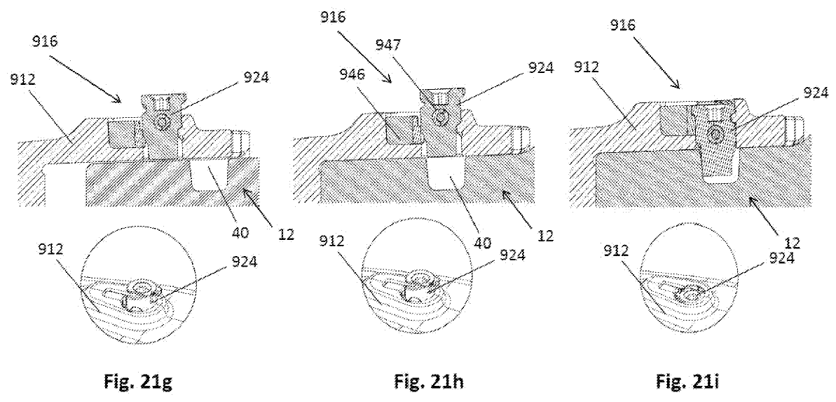

Referring now to FIGS. 10a and 10b. In some forms the locking assembly further comprises a holder in the form of a spring clip 56 for retaining the locking pin 24 within the locking hole 22. In some arrangement, when the pin 24 is in the transport or retracted positions, it is not retained in the locking hole 22 by the latch arrangement (for example by one of the detents 48′captured in a closed notch of the keeper 44′). Rather, in this arrangement the pin 24 may be retained by a holder in the form of spring clip 56. The spring clip is arranged to pass across an external opening of the locking hole. In the form shown in FIG. 10a and 10b, the spring clip 56 is shaped to nest around the drive arrangement 32 of the pin 24 when the pin is in the transport or retracted position. The spring clip acts to retain the pin within the locking hole 22 when in a retracted position and the helical engaging structures of the pin and wear member are not engaged. Additionally, the spring clip is resilient so as to bias the pin into the locking hole and towards engagement with the support structure 14.

The spring clip can be releasably mounted about an edge 58 of the opening of the socket 18 of the wear member. In the form shown in FIG. 10a, the spring clip 56 is configured as a cantilever having a free end 60 for engaging with the drive arrangement 32 of the pin 24 and a fixed end 62 wrapped around the edge 58 of the wear member 12. The free end in able to deflect about the edge 58 of the wear member so as to allow the pin 24 to displace out from the locking hole 22 and away from the socket 18 when the engaging structure 30 is not engaged. Further, the cantilevered configuration allows the spring clip 56 to apply a force to the drive arrangement 32 of the pin 24 so as to retain the pin within the locking hole and apply a force to the pin so as to press the pin into engagement with the support structure 14.

In some arrangements, the pin 24 may be retained in the locking hole by the latch in one of the transport or retracted position, and retained by the holder in the other, or the locking pin may be retained by both the holder and latch in one or both of the transport or retracted positions.

In an alternative embodiment, the locking pin 24 can be retained in the transport position by a holder in the form of a single-use frangible connection. These variations are disclosed in FIGS. 11a to 13b and 15a to 15c. The locking assembly of these variations shares many of the features of the earlier embodiments and for convenience, the same reference numerals are used for the same features of earlier embodiments but with the prefixes “1”, “2”, “3” or “4” to distinguish between those variants. The frangible connection may take the form of a glue applied to specific interfaces between the locking pin and the locking hole to hold the pin in the locking hole during transportation and when the wear member is not mounted to a support structure. When a wear member is mounted onto a support structure, the frangible connect is designed to break, or shear, when the support structure presses against the leading end of the pin. Alternatively, the frangible connection can break upon the application of torque to the drive arrangement of the pin. Once the frangible glue connection is broken, the locking pin is only loosely retained in the locking hole.

Referring now to FIGS. 11a and 11b. A single-use frangible connection may be a ‘tear-off’ cap 164. The tear-off cap can be designed to enclose a portion of the locking pin 124 so as to retain the pin in a transport position when not mounted to a support structure. In some forms, the cap can be releasably mounted into the hexagonal recess 134 of the drive arrangement 132.

As best shown in FIG. 11b, the cap can comprise an arm 166 extending from the mounted portion and retained at the interface between latch 148 of the locking pin 124 and the locking hole 122. The arm is held securely between at the interface by the pressure applied from the resilient portion 150 of the latch 148. Correspondingly, the locking pin is held in a transport position, resistant to moving from the transport position without a threshold force being applied. Once the frangible cap connection is broken, the locking pin is only loosely retained in the locking hole.

Various methods can be utilised in order to remove the cap and move the locking pin from the transport position into the extended position. In some forms, the cap can be designed to break, i.e. shear apart, if twisted from the locking hole upon when a tool rotates the pin about the drive arrangement 132. The arm may be perforated to create a weak point so as to direct the break to occur at a specific location on the arm. In this form, once torn from the arm, the cap may be re-used, i.e. reinserted into the hexagonal recess 134 to protect against the ingress of fines.

The cap may be pulled from its position by an operator. The length of the arm may be designed such that it is short enough to ensure that it pulls out from between the latch and the wall if the plug is removed by a pulling force.

In a variation shown in FIGS. 15a to 15c, the wear member 412 can be formed to comprise one or more holding formations in the form of re-entrant surfaces 465 adjacent the outer rim of the locking hole 422 such that holder in the form of a removable cap 464 having a pair of clips 466 with a correspondingly shaped lug 467 can be snap fit thereat so as to cover over the pin 424. The cap 464 comprises a body 462 having a diameter that covers over both the pin 424 and locking hole 422 in use. The side walls of the body 461 comprises an embossed portion 471 that aligns with each clip 466 and extends for the length of the side wall 461. Each clip 466 comprises a thinner leg 468 that extends towards the lug 467, with the lug 467 having a ramped body 469 and a catching portion 470 whereby in-use the cover 464 can be snap fit into engagement with the re-entrants 465, and retained thereat by the interaction between the catching portion 470 and the inwardly projecting wall portion 463 at the in-use outer facing side of the re-entrants 465. The removable cap 464, when located over the pin 424 and locking hole 422 in use, is thus able to be retained during transport and can protect the drive arrangement 32 and locking hole 422 from the ingress of fines, dirt or other fouling. The thinner leg 468 of each clip 466 has a length such that, when the clips 466 are engaged in the re-entrants 465 a gap exists between the underside of the embossed portion 471 and the outer surface of the wear member 412 in use. Thus, in order to remove the cover 464, the notches formed by the underside of the embossed portion 471 can be accessed by a tool (e.g. screwdriver) so as to allow a user to push the clip 466 inwards, out of the corresponding re-entrants 465, and thus enable the user to pry the cover 464 off the locking hole 422 in a lever-like motion. After cover 464 has been removed, the pin 422 is able to fall out of the locking hole 422, for example if the wear member 412 is upended. In another form, the cover 464 may be forced to disengage the wear member on fitting of the wear member to the support structure under movement of the locking pin due to the cam action described above.

Referring now to FIGS. 12a to 12c. A further form of the single-use frangible connection may be a detent 268 that can extend from the wall of the keeper 244.

Referring to the form shown in FIG. 12a, the detent can be a small protrusion from the wall of the keeper. The detent in this form can hold the pin 224 in a position so that it cannot move from the transport position when without applying a threshold force to the pin 224. In-use, once the pin has been forced, i.e. pressed into the locking hole and past the detent, the detent is sheared from its position. In other words, the interference between the latch and the detent wipes the detent from its position on the keeper. Once the pin is pushed past the detent and the detent is removed, the pin is no longer retained within the locking hole and can fall from its position the wear member is upended.

Referring now to the detent 268′ shown in FIG. 12b. In this form, the detent mounted to the wall of the keeper 244 and is flared outwards, i.e. away from the central axis of the locking hole 222. The flared-shape of the detent narrows the diameter of the locking hole such that the latch is only compressed when the leading end of the pin encroaches the wear member socket. In this way the pin can only be retained in the locking hole when the leading edge encroaches into the socket, i.e. past the open end of the locking hole.

Referring now to the detent 268″ shown in FIG. 12c. In this variation, the detent 268″ is flared inwards, i.e. towards the central axis of the locking hole 222. This flared-shape creates a ramp that directs the locking pin towards the wear member socket 218. The ramp prevents the latch ‘riding-up’ and outwards from the locking hole 222 when the wear member is e.g. upended. Due to compression of the latch by the ramp, the locking pin will be pushed back automatically into a natural resting position. The neutral resting position can be determined according to the angle of the ramp. The ramp angle can be designed to ensure the leading end of the pin is always encroaching into the wear member socket. Further, the angle of the ramp can ensure that the pin will move into an axially aligned position within the locking hole.

In an alternative to the above, the detents in the wall may not shear and thus become a permanent fixture of the locking hole 222.

Referring now to FIGS. 13a and 13b. In some forms, the single-use frangible connection may be a tie 370. The tie can be arranged to wrap around a portion of the wear member 312 and the locking assembly 314 to removably secure the pin in a transport position.

In the form shown in FIG. 13a, a hole 372 is provided in the wear member 312 for receiving the tie. In this form, the tie is threaded through the hole 372 and the wear member socket to wrap around the pin 324.

In another form as shown in FIG. 13b, the tie is wrapped externally around the wear member 312 to hold the locking pin in a transport position.

Additionally, the tie can block access to the hexagonal recess 334 of the drive arrangement such that the tie must be removed before the locking pin can be moved into an extended position.

Referring to FIGS. 16a-k, a further embodiment is disclosed of the locking assembly 516. The locking assembly 516 shares many of the features of the earlier embodiments and for convenience, the same reference numerals are used for the same features of earlier embodiments but with the prefix “5”. In this regard, the locking assembly includes locking pin 524 that has component 536 of an engaging structure 530 in the form of a helical arrangement and that engages with a complementary component of the engaging structure 538 formed on an interior surface of the locking hole 522 and causes axial movement of the pin 524 relative to the wear member 512 on rotation of the pin.

In this embodiment, the primary difference is that the retaining arrangement 542 includes two retainers (or latches)—an upper latch 546 (FIG. 16c) and a lower latch 547 (FIG. 16d).

Both the upper and lower latches comprise respective resilient portions (580, 550) and rigid portions (582, 548′).

The lower latch 547 functions in a similar manner to the latch described above and has a resilient portion 550 and a rigid detent 548″ and is arranged to shorten (compress) under load. In the illustrated form the lower latch is generally cylindrical and the detent 548′ is generally hemispherical. However, the latch is not limited to these shapes. In some forms, the resilient portion 550 of the lower latch 547 may include a hollow portion to enhance its ability to compress. In other forms, the resilient portion can be a solid structure.

Similar to the earlier embodiments, the lower latch 547 is disposed in the body of the locking pin 524. In contrast with the previously described embodiments, the locking pin 524 includes a blind bore 549 as opposed to a through hole and the lower latch is single sided (ie.it has a detent 548′ only on one end of the latch 547). In use, the resilient portion 550 of the lower latch 547 functions to bias the detent 548 against the wall of the locking hole 522 and enables the detent to locate into keepers (544′ and 544″) as discussed in more detail below.

A variation of the lower latch 547 is disclosed in FIG. 161, where the resilient member 550 is formed as composite structure having a compression spring 585, which is encapsulated in a resilient matrix 587, typically a rubber or elastomeric material. The resilient material further includes a core to receive the resilient matrix as it deforms on compression of the spring 585. In one form, the core may be formed of an open cell structure such as a foam. In manufacturing of the latch 547, in one form, a rubber (preferably an elastomer with good thermal performance, for example silicone) is vulcanised into the voids of the spring. The internal core of the vulcanised spring incorporates a foam plug 589 which is manually inserted. The foam plug not only allows the rubber to deform on compression, it also aids to keep fines out during service. Typically, rubber has poor elastic performance in very hot or very cold digging environments, and therefore it is desirable to use materials that can work more effectively in such conditions. A metal spring achieves this, however, a metal spring on its own has drawbacks including the gaps between the coils can fill with fines rendering the latch unusable, and it is challenging to achieve the same stiffness as a solid rubber latch—which in turn reduces the pins ability to resist unwinding in service. Having the combination of the spring in the rubber matrix addresses the shortcomings of the metal spring whilst still allowing the benefits of using the spring being that it can operate in a broader temperature range than achievable with rubber. It is to be appreciated that whilst the composite latch is disclosed in the latch assembly of FIGS. 16a-16i, a similar structure may be used as the resilient member in the other embodiments disclosed.

In the embodiment of FIGS. 16a—161, the locking hole 522 forms part of a more complex shaped lock receiving arrangement 590 formed in the wear member 512. This lock receiving arrangement 590 further includes a cavity 543 (see FIG. 16h) that opens to the locking hole 522. This cavity is arranged to receive the upper latch 546. The cavity includes a recessed portion 545 which is arranged to receive a nose portion 551 of the upper latch 546 so as to capture the upper latch 546 in the wear member 512. When installed, an inner face 553 of the latch 546 projects into the locking hole 522. This inner face 553 is arranged to bear against the body region of the locking pin 524 to assist in stabilising the locking pin 524 in the locking hole. Moreover, the inner face may include a chamfer 584 that is arranged to engage with a complementary chamfered surface 586 on the locking pin 524. This allows the latch to compress easily when the pin is inserted into the point. The two chamfers slide against each other when the pin is first installed and rotated. Without the chamfers, the lock may tend to bind or be more difficult to install.

In some forms, the upper latch 546 is arranged to bear against the locking pin to resist lateral movement (being translation and or pivoting of the locking pin in the locking hole) which may otherwise occur under operational load. In this way, the upper latch 546 provides some shock absorbing capability to the locking pin when installed.

In the locking assembly 516, the primary torsional resistance to the locking pin 524 is provided by the lower latch 547 and its engagement in with the two keepers 544′ and 544″. As such, the locking arrangement can function without the upper latch 546. As such in this regard, the upper latch may be considered optional to the basic latching function. The purpose of the upper latch 546 is to provide the additional shock absorbing capability to the locking pin to enhance its function under load. It can also provide other retaining functions (as discussed below).

The use of the upper latch may be incorporated solely to provide the shock absorbing capability and therefore may not including any “latching” capability. The use of the term, “upper latch” should not be construed as limiting to the component to be used necessarily in conjunction with latching in this arrangement.

In one form as best shown in FIGS. 16j and k, the two keepers 544′ and 544″ are located on the wear member 512 in spaced relation and arranged to receive the detent 548′ of the lower latch 547 when the locking pin 524 is moved under rotation from a retracted to an extended position. In one arrangement, for transport, the locking pin is installed in a retracted position with the rigid detent 548′ of the lower latch 547 in engagement with the keeper 544′. The frictional contact in this position between the rigid detent 548′ and the keeper 544′ secures the pin from further rotation during transport. Furthermore, in this position, the inner face 553 of the upper latch 546 is engaged under bias from its resilient portion 580 being under compression with the pin body to maintain the locking pin 524 in the wear member and resist its falling out.

In one form, the upper keeper 544′ may be reshaped so that it does not retain the detent 548′ when first installed in the locking hole 522 but rather provides a clearance 588 for the detent so that it does not engage with the wear member. This arrangement is best shown in FIGS. 16g, and 161. The lead in 588 allows the pin to be inserted into the point by hand. The lead-in creates room for the lower latch 547 to be inserted into the pin cavity. In one form the ‘transport position’ the pin is held only by the friction from the upper latch.

Further, in comparison between FIGS. 16h and 16j, the engaging structures (thread) 538 can be similarly adjusted depending on whether the lead in 588 is provided or whether a more defined notch 544′ is provided as shown in FIG. 16k. When the lead in 588 is provided, the thread 538 is extended further within the locking hole 522 surface to provide an opposing edge to the lead in 588 to facilitate initial installation of the locking pin 524.

In one form, neither the upper or lower latch provide a defined position when first installed. In this way there is no defined retracted or transport position. Rather the locking pin is able to be merely inserted and becomes engaged with the upper latch 546 which provides some frictional resistance and then can be rotated and driven axially under the helical arrangement of the engaging structure 530 as per a more conventional threaded arrangement.

Once the pin 524 is ready to be installed to lock the wear member 512 to the support structure 14, it is rotated (through for example approximately 180 degrees) to allow the rigid detent 548″ of the lower latch 547 to come in contact with the second keeper 544″. This corresponds to the locked or latched position.

In some forms, the pin 524 includes a radial projection 551 at its second end 528. The radial projection 551 is configured to engage a complementary surface 558 on the wear member 512. In the illustrated form, the complementary surface forms part of the cavity 543 that houses the upper latch 546. This arrangement creates a hard stop mechanism that prevents the pin 524 from rotating further and thus moving along the axial direction.

As best illustrated in FIG. 16f, this radial projection 555 may further be configured to engage with an upper portion 559 of the inner face 553 of the upper latch 546. This engagement is a camming engagement where a leading edge of the radial projection 555 rides over a projection 560 on the inner face 559. Such an arrangement enables frictional contact to be established between the upper portion 559 of the inner face 553 and the radial projection 555 on the pin thereby providing a further mechanism to retain the pin into locked or extended position. In this arrangement, the profile of the radial projection 555 comprises a profile that is corrugated/undulating.

In other forms, the radial projection may not include this additional locking function. For example, as shown in FIG. 16g, the radial projection has a smooth profile that is complementary to a smooth profile on the upper portion 559 of the inner face. In this case, there is no locking effect achieved and the upper latch 546 serves to absorb impact loads.

As with previous embodiments, the latching arrangement 542 also comprises a helical engagement structure in the form of a groove 536 on the locking pin 524 and thread 538 on the wear member. However, the threads on the wear member of the illustrated embodiment are located such that during installation of the pin 524 in the wear member 512, the lower latch 547 does not travel over the threads. Moreover, the threads can be positioned outside the load bearing zone between the wear member and pin that could otherwise result in crushing of the thread 538.

During assembly, the upper latch 546 is first installed in the cavity 543 of the wear member 512. Following this, the pin 524 is inserted such that the rigid detent 548″ of the lower latch 547 comes into frictional contact with the keeper 544′. Once the pin 524 is ready to be installed, the pin is rotated by 180o until the radial projection 555 encounters the complementary surface on the wear member 12 and comes to a hard stop. At this position, the rigid detent 548″ of the lower latch 547 will be in frictional engagement with the keeper 544″ in the pin cavity of the wear member. Simultaneously, the upper portion 559 of the upper latch 546 will also be in frictional engagement with the pin 524. In this locked position, the lower and upper latches will be located at an angle of 90o to each other.

An advantage of this embodiment is that, it can allow the application of locking force in two planes. Thus, the pin can be locked using forces that act in two different directions thus allowing for a much better fit within the wear member/adapter. As discussed above, the latching arrangement 542 can work with just the lower latch 546 itself (i.e. without the upper latch 547). However, the addition of the upper latch provides further advantages of this embodiment, including the ability of the upper latch 546 to absorb impact loads, to resist lateral movement (being translation and or pivoting) of the pin 524 within the locking hole 522, to allow latching of the pin 524 in transverse axial planes, and to provide redundancy to the latch function.

FIGS. 19a to 19e illustrate a variation on the wear member 512 used in the wear assembly of FIGS. 16a to 161. Again, as the wear member 712 shares many of the features of the wear member 512, like features have been given like reference numerals except that the prefixed used has been replaced by a “7”.

The primary difference in the wear member is that the interior shape and features of the lock receiving arrangement 790 is not formed directly as a casting of the wear member 712 but is provided as part of an insert 792 that is manufactured separately (say for example by an investment casting process) and is then placed within a mold (typically being a sand mold) and the wear member 712 is cast around the insert. The advantage of this arrangement is that the insert can be manufactured to a finer tolerance than generally possible under the sanding casting process usually employed in wear member manufacture. This in turn can assist in improving the performance of the resulting lock assembly incorporated in the lock receiving arrangement. Other advantages may include the ability to use different material for the insert as compared to the balance of the wear member 712 thereby allowing better control over performance and durability of the lock.

To ensure adequate performance, it is important that the insert 792 is adequately secured to the wear member 792. This may be achieved in a number of ways. In one form, the insert may be caused to fuse with the wear member as it is cast around the insert, such that the insert becomes intimately bonded with the wear member 712. With this arrangement the separation between the insert and the wear member is less distinct as there is not a clear material separation between the insert the cast wear member.

In another form, the insert may be mechanically keyed to the cast wear member as the liquid metal is able to flow around the exterior 793 of the insert 792. FIGS. 19b to 19e show various keyed arrangements. In 19a, a single flange 794 is provided on the inner end of the insert adjacent the cavity 718 which prevents ejection of the insert on the outer side of the wear member but may allow the insert to be knocked into the cavity if required. In the other variations shown, the insert is fully captured by accommodating a recessed profile 795 (FIG. 19c) or 796 (FIG. 19e) on the exterior of the insert 792, or by one or more intermediate projecting flanges (such as flange 798, FIG. 19d).

In a further form, the insert is secured by a combination of bonding (fusing) and mechanical arrangement. Further, whilst the insert has been shown in relation to the embodiment of FIG. 16a to FIG. 16k, it is to be appreciated that it may be used to define the locking hole of the wear member of other embodiments disclosed.

A further variation of the locking assembly 516 shown in FIG. 16a to FIG. 161 is shown in FIG. 20a to FIG. 20d. As the lock 816 shares many of the features of the lock 516, like features have been given like reference numerals except that the prefixed used has been replaced by an “8”.

The primary difference with the lock 816 is in the design of the upper latch or retainer 846. In the lock 816, the retainer 846 is formed from a spring-like or resiliently flexible material, such as spring steel into a substantially C-shaped clip.

The wear member 812 comprises a ledge-like cavity 892 around the inwardly facing sidewalls of the locking hole 822, the cavity being substantially C-shaped so as to generally correspond to the shape of the retainer 812. The retainer 812 is sized so as to enable insertion into the cavity 892 from outside of the wear member 412 with the outer diameter of the retainer 846 fitting within the inner diameter of the cavity 892.

As best seen in FIG. 20b, a shoulder 895 is formed on either side of a portion 894 of the sidewalls that juts inwardly towards the centre of the locking hole 822 from the circumference of the otherwise circular ledge-like cavity 892 to thereby provide an interruption to the cavity. Each shoulder faces generally radially to an axis of the locking hole 822, and is adapted such that, in use, the distal ends of each of the two arms 893 of the C-shaped retainer 846 locate adjacent thereto, so as to abut and/or interact with one of the two shoulders within the locking hole 822 (e.g. FIG. 20d). The interaction between the shoulders 895 and the distal ends of each of the two arms 893 of the C-shaped retainer 846 act to prevent the retainer 846 from rotating around within the cavity 892 in use.

The retainer 846 has an interference fit with the locking pin 824 as, in its natural state, the substantially circular aperture formed by the arms 893 and body of the C-shaped clip has a smaller diameter than the diameter of the pin 824. As the locking pin 824 is engaged between the arms 893 of the retainer 846, the arms 893 can be resiliently flexed outwards, with the inward bias of the arms 893 (towards their natural state) applying a positive force that clamps against the locking pin 824 and resists rotation of the pin by friction. The positive force of the inward bias of the arms 893 against the locking pin 824 can generate a friction based torsional resistance that assists the retainer 846 in gripping and retaining the locking pin 824 in use. This torsional resistance can help reduce the effects of vibrations that may otherwise cause the locking pin 824 to rotate and come loose, or from moving axially towards the retracted position. The frictional resistance may therefore form part of the retaining arrangement (operating in conjunction with the lower latch 847) to maintain the locking pin 824 in the locking hole 822 under axially loading on the pin 824. The frictional resistance can be overcome with a wrench applied by an operator during installation or removal of the locking pin 824.

A further variation of the locking assembly 516 shown in FIG. 16a to FIG. 161 is shown in FIG. 21a to FIG. 21i. As the lock 916 shares many of the features of the lock 516, like features have been given like reference numerals except that the prefixed used has been replaced by an “9”.

A feature of the lock 916 is that the locking pin 924 is inserted into the locking hole 922 independent of the lower latch 547. This arrangement allows the locking hole design to be simplified (as it does not require the same lead entry 588) on the interior wall of the locking hole to accommodate the lower latch when the locking pin is installed together with the lower latch. Also, it relieves compression on the lower latch during installation.

To enable this arrangement, the cavity 943 forming part of the lock receiving arrangement 990 is modified to accommodate the drop in of the lower latch. A complementary modification is made to the upper latch 946 so that it fits within the cavity. In the form as shown, the cavity 943 includes a planar back wall 991 and does not include the undercut 545. This assists in installing the upper latch 946 after installation of the locking pin 924.

The installation sequence of the locking assembly is shown in FIGS. 21a to 21f. In a first step (FIG. 21a), the locking pin 924 (without lower latch) is inserted into the locking hole and the helical components of the engaging structure 530 on the locking pin and interior wall of the locking hole can engage. The pin can then be rotated to towards the fully extended position as shown in FIG. 21b. This rotation is easily made as the locking pin is not subject to torsional resistance as otherwise would be provided by the upper and lower latches (946 and 947).

In use, the locking pin 924 is rotated towards the extended position to a position where the locking bore 949 aligns with the cavity 943 and just above the floor of the cavity. In this position, the lower latch 946 is able to be dropped into the cavity 943 to be aligned with locking bore 949. Once in that position, the latch can then be translated into the bore 949 and is thereby captured within locking pin body 924. This sequence is best illustrated in FIG. 21b. Once captured, the locking pin assembly including the locking pin 924 and captured lower latch 946 can then be rotated to a retracted position (FIG. 21c), a transport position (FIG. 21e) where the leading end may encroach into the wear member main cavity 918, or an intermediate position where it is substantially flush with the inner wall of the wear member (FIG. 21d and FIG. 21f). In moving to these positions, the lower latch would compress as it moves against the inner wall of the locking hole 922.

In the illustrated form, when in this intermediate position, the upper latch is then abled to be inserted into the cavity 943, thus rendering the locking assembly fully operational.

Whilst the fitting of the lock assembly 916 to the wear member 912 may be done onsite, typically it is preinstalled and the wear member 916 is delivered on site with the locking assembly installed as an assembly. As such once installed, the locking assembly 916 may be moved to any one of the retracted position or transport position as required before installation on the support structure 12 as required and as detailed above in relation to the previous embodiments.

Once in this operational state and delivered to site, the wear member can then be fitted to the support structure 14 in a similar manner as discussed above and as shown in the sequence of FIG. 21g to FIG. 21i. where the wear member 912 is fitted over the support structure with the locking pin 924 in a retracted position and then rotationally driven into the recess 40 and into the locking position to lock the wear member to the support structure 14.

Referring now to FIGS. 17a-17e, a further embodiment of the lock 616 is disclosed. Again, the lock 616 shares many of the features of the earlier embodiments and for convenience, like features have been given like reference numeral but with the addition of the prefix “6”.

In this embodiment, the latching arrangement 642 comprises of a single latch 646 (similar to the upper latch 546 in the previous embodiment) that locates in a cavity 643 of the wear member 612. However, in this case, the latch 646 provides both the torsional resistance to the locking pin to maintain the pin in its locked position and to maintain the pin firmly within the locking hole 622.

The latch 646 comprises a rigid detent portion 682 that has an inner face 653 that bears against the pin 624 and a resilient backing portion 680. The latch 646 locates in the cavity 643 of the wear member and is retained thereby in an undercut arrangement 645, as per the earlier embodiment.

The resilient portion 680 is arranged to compress in operation to apply a bias to the pin. Similar to the earlier embodiment, this bias provides a shock absorbing effect and is especially useful to buffer the impact of loads acting on the pin and thereby inhibit damage to the pin 624/locking hole 622.

To provide a latching function, the pin 624 incorporates a keeper 690 located on the body 631 of the locking pin 624 formed as a recess or notch within the pin body 631. The keeper 690 is arranged to move into register with the latch 646 as the pin is moved to its locking position. As it moves into register, the inner face 653 moves into keeper recess 690 (under the bias of the resilient member 680) thereby capturing the rigid detent portion 682 resisting further rotation of the pin 624 within the locking hole 622. The detent portion 682 and keeper 690 can be formed with appropriately chamfered edges to allow adequate entry and exit to the of the latch into the keeper recess to enable release of the lock 616 from the locking position to enable removal of the locking pin 624.

The pin 624 may comprise a radially extending projection 652 at its second end 626 similar to the previous embodiment described. This radially extending projection can engage with a complementary surface 658 on the wear member 612 to prevent further rotation of the pin 624 once the pin is locked into position. Further, the second end 626 may also comprise a cut-away section 692 or discontinuity to provide clearance for the thread 638 (which may extend to the exterior surface of the wear member) when the pin is in its locked position. In this way the end 626 of the pin can be located at or below the exterior of the wear member when in the locked position (see FIG. 17e).

During assembly, the latch 646 is first inserted into the cavity 643. Next, the pin 624 is inserted in the locking hole 622 and rotated which causes the engaging surfaces 630 and 638 to engage progressively brings the body 631 of the pin into engagement with the inner face 653 of the latch 646 causing the resilient member 680 to compress and increasing frictional contact between the pin 624 and the latch 646. In the present embodiment, the inner face 653 may include multiple mating surface (694,696, 698) at various inclinations that facilitates this progressive engagement. The latch engages the pin on installation of the pin in the locking hole and progressively increases its retaining force as the pin is rotated into the locking hole towards the locked position and engages the different surfaces (being surface 694 initially, then surface 696, and finally surface 698). For example, during transport, the pin 624 can be rotated to a position (see FIG. 17d) such that only surface 694 of the inner face 653 of the detent 682 engage in a frictional contact with the pin body. This may fix the position of the pin sufficiently to enable it to be moved/transported. During installation of the pin on the wear member, the pin can be rotated further to a position shown in FIG. 17e whereby the inner surface 653 is in full mating condition with the pin body and aligns with, and locates in, the keeper 644 thus providing the latched arrangement. This corresponds to the locking position.

A feature of this design is that the locking pin 624 has no bore/ through hole to accommodate an integrated latch as per the earlier embodiments. This has an advantage as the bore/through hole can act as a stress raiser that forms regions of concentrated stress on the locking pin that may impact pin performance

Referring now to FIGS. 18a to 18c, a further feature of the lock (in any of the forms described above) relate to the relative inclination of certain surfaces of the pin and the wear member or support structure. For convenience, this feature will be described with reference to the lock 516 of embodiment of FIGS. 16a-k, but it will be appreciated that it is applicable to the other embodiments as well as other locking designs outside the current disclosure.

Under loading conditions on the wear member, there is a tendency that the wear member will rotate on the support structure particularly as loads parallel to the longitudinal centreline of the assembly are induced (because the taper provided on the stabilising surfaces between the support structure and wear member). The closer these stabilised flats become to horizontal, or parallel to the longitudinal centreline of the assembly, the less resultant horizontal load is placed on the wear member, which thus has to be counteracted by the resistance of the lock to maintain the wear member on the support structure. The stabilisations are not completely parallel to the longitudinal centreline for two reasons; first these parts are almost all either cast or forged and some taper, or draft, must be used on these parts or they would not be able to be removed from the mold. Secondly, if these stabilised flats both front and rear, which are generally designed to be the load bearing pads for the forces on the wear member, were completely horizontal then installing a wear member onto the support structure would require larger clearances to ensure the assembly could be completed. The wear member would also be more likely to become wedged onto the support structure making them harder to be removed. A slight taper on these bearing pads is therefore required for easier manufacture and also assembly and disassembly of the parts.

This taper and also the required clearance between the support structure and the wear member allow for a certain amount of movement between the support structure and the wear member when the wear member is loaded while in use. The larger the clearance, and the larger the taper, means that there is generally more movement of the wear member on the support structure when a load is applied to the wear member. This necessitates a very robust lock, which can hold the wear member onto the supporting structure even in the presence of these high loads.

Furthermore, with the added desirability of locks that provide a hammerless system, such as those disclosed in this disclosure, the accommodation of the horizontal loads become more problematic as the locks need to be able to be installed and removed without a hammer so as such need to have some tolerance or movement to accommodate installation and release of the locking pin.

In accordance with this further aspect of the disclosure, at least one bearing surface defined by an internal wall of the locking hole and or support structure is configured to be angularly offset from at least one corresponding bearing surface defined by an external surface of the locking pin when the wear member is installed on the support structure, and the lock is in the locked position, and without any load transfer on the wear assembly from ground penetration.

Moreover, when under loading condition, the angular offset is designed to reduce (i.e. the bearing surfaces move more into mating arrangement) as the locking pin is caused to move relative to the wear member and the support structure, particularly under the horizontal induced loads discussed above. As such, when a load is placed on the wear assembly from ground penetration in use, the bearing surfaces are biased into increased surface engagement.

With this arrangement, the surface area contact is increased under the bias of the load transfer. The profile of the at least one bearing surface of the pin and/or locking hole and/or support structure may be planar or include a radius or radii of curvature so the surface is arcuate.

Turning to FIGS. 18a to 18c, two regions are identified (700 and 702) in the lock 516 where opposing surfaces are designed to have the above mentioned angular off set.

Region 700 is a rearward section (relative to the tip of the wear member) between the body 531 of the pin 524 and interior surface of the locking wall 522 (being in opposing relation to keeper 544″). Region 702 is a forward section between the lower end of the pin (towards the first end 526) and a rear surface of the interior wall 552 of the cavity 540 of the support structure 514.

The angle of the offset is typically less than 5 degrees but can be adjusted based on the tolerance in the lock, the expected design load conditions. In one form, the feature may increase the life of the support structure and pin by providing a larger bearing contact surface area between the parts (more contact surface area =less contact stress). Offsetting the angle between the pin and support structure accommodates for the rotation/tilt of the pin relative to the nose due to the initial gaps closing up. The pin and support structure bearing faces ‘roll’ into alignment when the wear member is under load. Similarly, this may be applied to the other pin bearing faces (e.g. between pin and wear member (region 700)).

A further benefit of this arrangement when applied to the lock 516 is that the wear member can be held firmly on the support structure by the action of the compressed/pre-loaded latch 546 (not shown in FIGS. 18a to 18c). The biasing force applies a moment on the pin (as represented by the arrows in 18c). This helps maintain the initial alignment of all the parts and provides tactile feedback to the installer that the wear member is securely installed on the support member.

A further advantage of the angular offset of the bearing surfaces is that there may be greater clearance provided when the pin is installed or removed with the wear member in an unloaded condition. This can facilitate installation and removal of the pin.

Further, the wear assembly may be manufactured to suit a particular digging application. For example, specific bearing surfaces may be predetermined to be angularly offset relative to the corresponding support structure bearing surfaces in the installed position. These are the surfaces that are anticipated to wear the most in the particular digging application, and it may be any combination of corresponding bearing surfaces.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-79. (canceled)

80. A wear member assembly for attaching to a support structure of earth working equipment comprising:
a wear member comprising a body having a first end, an opposite second end that incorporates a cavity configured to receive the support structure, and a locking hole extending in the wear member body along a locking hole axis from an exterior of the wear member to the cavity; and
a lock to releasable secure the wear member to the support structure, the lock comprising a lock body having a first end region; and a retaining arrangement configured to resist movement of the lock body in the wear member under loading in the direction of the locking hole axis,
the lock body being movable within the locking hole from a position where the first end region of the lock body is sufficiently clear of the cavity to permit installation of the wear member onto the support structure to a locked position wherein the first end region extends into the cavity so as to engage with the support structure to secure the wear member with the support structure, and
the retaining arrangement comprising an engaging structure having a component on an exterior surface of the lock body and a complementary component disposed on an interior wall defining at least part of the locking hole, and at least one retainer configured to provide torsional resistance to the lock body to restrain rotational movement of the lock body in the locking hole; wherein
the engaging structure is helical, or part helical, having a steep pitch that is configured to promotes rotation and axial movement of the lock body under loading on the lock in the direction of the hole axis such that, under the axial loading, the axial movement of the lock body in the locking hole between the position where the first end region of the lock body is sufficiently clear of the cavity and the locked position is controlled by the torsional resistance provided by the at least one retainer.

81. A wear assembly according to claim 80, wherein the engaging structure is configured such that lock body is rotatable within the locking hole through about 180 degrees from the position where the first end region of the lock body is sufficiently clear of the cavity to permit installation of the wear member onto the support structure to the locked position.

82. A wear assembly according to claim 80, wherein the lock further comprising a stop arrangement to prevent movement of the lock body past the locked position.

83. A wear assembly according to claim 82, wherein the stop arrangement is provided between the lock body and the wear member.

84. A wear assembly according to claim 83, wherein the lock body comprises a second end region opposite the first end region, and the stop arrangement comprises a radial projection at the second end region and a complementary engaging surface disposed on the wear member, the stop arrangement being visible from the exterior of the wear member.

85. A wear member assembly according to claim 80, the lock body including a bore extending transverse to the lock body axis wherein the at least one retainer comprises at least one latch disposed in the bore and having a detent movable transverse to the locking hole axis, the detent being arranged to engage the interior wall defining at least part of the locking hole so as to provide frictional resistance to movement of the lock body in the locking hole.

86. A wear member assembly according to claim 85, wherein the at least one latch further comprises a resilient member operative to allow transverse movement of the detent on deforming of the resilient member, the resilient member comprising a compression spring encased in an elastomeric material.

87. A wear member assembly according to claim 85, wherein the interior wall surface further comprising at least one notch operative to receive the detent to inhibit rotation of the lock body in the locking hole.

88. A wear member assembly according to claim 80, wherein the at least one retainer is separate to the lock body and installed in the locking hole.

89. A wear member assembly according to claim 88, wherein the at least one separate retainer includes an inner face that bears against the lock body and a backing member.

90. A wear member assembly according to claim 89, wherein the backing member is a resilient backing member.

91. A wear member assembly according to claim 88, wherein the separate retainer resists lateral movement of the lock body within the locking hole.

92. A wear member assembly according to claim 91, wherein the separate retainer comprises a resilient member that is arranged to apply a bias to the lock body in a direction that is transverse to the locking hole axis.

93. A wear member assembly according to claim 92, wherein the resilient member comprises a compression spring encased in an elastomeric material.

94. A wear member assembly according to claim 89, wherein the lock body includes a keeper structure thereon to receive the separate retainer, and when so received, the retainer resists the lock body from rotation within the locking hole.

95. A wear member assembly according to claim 80, wherein the retaining arrangement comprises a plurality of retainers, the retainers being arranged to be angularly spaced apart about the lock hole axis when the lock body is in a locked position.

96. A wear member assembly according to claim 95, wherein the lock body including a bore extending transverse to the locking hole axis wherein one of the plurality of retainers comprises at least one latch disposed in the bore and having a detent movable transverse to the locking hole axis, the detent being arranged to engage the interior wall defining at least part of the locking hole so as to provide frictional resistance to movement of the lock body in the locking hole.

97. A wear member assembly according to claim 96, wherein one of the plurality of retainers is the separate retainer separate to the lock body and installed in the locking hole, the at least one separate retainer includes an inner face that bears against the lock body and a backing member.

98. A wear member assembly according to claim 97, wherein the backing member is in the form of a resilient backing member.

99. A wear member assembly according to claim 80, wherein the wear member and lock being configured so as to enable the wear member and lock body to be transported as an assembly with the lock assembly secured to the wear member by the retaining arrangement.

100. A wear member for attaching to a support structure of earth working equipment, the wear member comprising a body comprising a first end, an opposite second end that incorporates a cavity configured to receive the support structure, and a locking hole extending in the body to the cavity, the locking hole being arranged to receive a lock to secure the wear member to the support structure and being defined by an interior wall surface that incorporates a component of an engaging structure arranged to engage with a complementary component of the engaging structure disposed on an exterior surface of the lock to form at least part of a retaining arrangement to resist movement of the lock in the wear member under loading in the direction of the hole axis, the component of the engaging structure is formed as one or more ribs that projects into the locking hole, the engaging structure is helical, or part helical and the pitch of the engaging structure promotes rotation and axial movement of the lock body under loading on the lock body in the direction of the lock body axis.

101. A lock for securing a wear member to a support structure, the wear member having a body that incorporates a cavity configured to receive the support structure, and a locking hole extending to the cavity, the lock being arranged to be movable within the locking hole and comprising:
a lock body extending along a lock body axis and having a first end region for engaging with the support structure to allow securing of the wear member with the support structure; and
a retaining arrangement operative to resist movement of the lock in the wear member under loading in the direction of the lock body axis, the retaining arrangement comprising:
a component of an engaging structure on an exterior surface of the lock body which is arranged to engage with a complementary component of the engaging structure disposed on an interior wall defining at least part of the locking hole, and
at least one retainer operative to provide torsional resistance of the lock body in the locking hole, the retainer comprising a resilient member.

102. A lock according to claim 101, wherein the resilient member includes a compression spring encased in an elastomeric material.
